(19) United States
(12) Patent Application Publication
(10) Pub. No.: US 2017/0089424 A1
(43) Pub. Date: Mar. 30, 2017

(54) ENGINE AND GEAR TRAIN COMBINATION EQUIPPED WITH A PULSE COMPENSATOR

(71) Applicant: Delbert Tesar, Austin, TX (US)

(72) Inventor: Delbert Tesar, Austin, TX (US)

(21) Appl. No.: 15/279,415

(22) Filed: Sep. 28, 2016

Related U.S. Application Data
(60) Provisional application No. 62/233,697, filed on Sep. 28, 2015.

(51) Int. Cl. F16F 15/31; F02B 75/06

(52) U.S. Cl. CPC F16F 15/31; F02B 75/06; B60B 27/0047

(57) ABSTRACT

An engine and gear train combination is provided which includes an engine which drives a first crankshaft having a first gear disposed thereon; a second crankshaft having a second gear and a flywheel disposed thereon, wherein the second gear meshes with the first gear; and a pulse compensator having a central element which is pivotally connected on a first end thereof to a first set of lateral members and which is pivotally connected on a second end thereof to a second set of lateral elements. Each element of the first set of lateral elements is also pivotally connected to the second crankshaft, and each element of the second set of lateral elements is pivotally connected to a mount.

### CROSS-REFERENCE TO RELATED APPLICATIONS

The present application claims priority to provisional application U.S. 62/233,697 (Tesar), entitled “ENGINE AND GEAR TRAIN COMBINATION EQUIPPED WITH A PULSE COMPENSATOR”, which is incorporated herein by reference in its entirety.

### FIELD OF THE DISCLOSURE

The present disclosure relates generally to engine/gear train combinations, and more particularly to an engine/gear train combination which is equipped with a pulse generator.

### BACKGROUND OF THE DISCLOSURE

Recent improvements in engine technology, such as the development of superchargers and turbochargers, have resulted in the downsizing of internal combustion engines. Such improvements result in better fuel efficiency without compromising performance characteristics or vehicle form factors.

In particular, superchargers or turbochargers may be utilized to compensate for reductions in engine displacement or a number of engine cylinders, thus allowing performance characteristics to be maintained. The use of these devices may increase the torque potential of the engine, enabling the use of longer gear ratios in the transmission system. The use of longer gear ratios permits an engine to be operated at lower operating speeds, a result known as “down-speeding” of the engine. This, in turn, may result in improved fuel economy, operation of the engine at more efficient levels for a greater amount of time, and reduced engine emissions.

Despite the foregoing advantages, however, down-speeding also poses certain challenges. In particular, down-speeding may result in an undesirable increase in torque ripple at low operating speeds (for example, when the engine is operating at low idle speeds). Such torque ripple results from the periodic manner in which torque is delivered during each power stroke of the operating cycle of the engine.

The phenomenon of torque ripple is well known to the art and is discussed, for example, in U.S. 2014/0260777 (Versteyhe), entitled “Variable Inertia Flywheel”. FIG. 1, which is reproduced from Versteyhe, is a graph illustrating the torque output of an engine during a four stroke cycle. In this cycle, torque ripple occurs once for every two turns of a crankshaft for each cylinder of the engine. It will thus be appreciated that a four-cylinder engine will have two torque ripples per turn of the crankshaft, while a three-cylinder engine will have three torque ripples for every two turns of the crankshaft.

The amplitude and phase of the torque ripple typically varies with the operating speed of an engine and the load applied to it. Torque ripples may give rise to many undesirable side effects such as, for example, increased stress and wear on engine components, and exposure of these components to severe vibrations. These problems may adversely affect the powertrain and drivability of a vehicle.

In light of the foregoing issues, many attempts have been made in the art to reduce or eliminate the effects of torque ripple, and these efforts have resulted in the development of several different torque ripple compensator devices. However, while the torque compensator devices developed to date may have some desirable features, they also have several shortcomings.

For example, many torque compensator devices developed to date utilize a flywheel to compensate for torque ripple. One example of such a device, which is reproduced from Versteyhe, is depicted in FIG. 2. The device 51 shown therein utilizes a flywheel 53 whose inertia dampens the rotational movement of the crankshaft 55, thus facilitating operation of the engine running at a substantially constant speed.

However, the weight of the flywheel is a significant factor in such systems. In particular, a lighter flywheel accelerates faster, but also loses speed faster. Consequently, a lighter flywheel is found to permit good engine responsiveness and better control over the operating speed of the engine, but suffers from choppy power delivery and a faster loss in engine speed. By contrast, a heavier flywheel is found to retain speeds better than a lighter flywheel, but is also more difficult to slow down. Thus, while a heavier flywheel provides smoother power delivery, it also adversely affects the responsiveness of the engine and the ability to precisely control its operating speed.

Dual mass centrifugal pendulums are another type of torque compensator device known to the art. In many applications, the main torque ripple occurs at the second order. Dual mass centrifugal pendulums capitalize on this realization by utilizing a rotating mass with an internal (non-circular) cam profile to generate an opposite second order torque ripple to cancel out the second order main torque ripple. In particular, the centrifugal forces associated with the rotating mass generate a variable torque on the engine output shaft as the associated rollers move radially inwardly and outwardly from the engine output shaft by following the cam profile, thus counteracting the torque ripples generated by the engine.

However, in addition to the increase in weight associated with them, known variable inertia and damping systems such as dual mass centrifugal pendulums have poor adaptability. In particular, such devices are designed for worst-case operational scenarios, and must have enough mass to dampen vibrations at lower operational speeds. Consequently, these devices are typically designed for higher operational speeds, and have a tendency to inhibit vehicle performance and to reduce the reactivity of the engine.

Moreover, while some variable inertia and damping systems known to the art may compensate for the amplitude of torque ripples, most of these devices do not compensate for phase changes in the torque ripples generated by the engine. However, such phase changes are common and frequently result, for example, from changes in rotational speed of the engine and the load applied to it.

In light of the foregoing, efforts have been made in the art to develop a variable inertia flywheel which may be dynamically adapted for both the amplitude and phase of a torque ripple while minimizing interference with the operation of an internal combustion engine. One such variable inertia flywheel is disclosed in Versteyhe, an embodiment of which is reproduced in FIGS. 3-4 herein.

The variable inertia flywheel 100 of FIGS. 3-4 comprises at least two revolute joint assemblies 104, a roller guide 106, and a first actuator 108. The revolute joint assemblies 104 are in driving engagement with an output of an internal combustion engine 112. Each of the revolute joint assemblies 104 comprises a member assembly 121 and a roller guide 106. The roller guide 106 is disposed about the revolute joint assemblies 104. An inner surface of the roller guide 106 is in rolling contact with each of the rollers 120. The first actuator 108 is in engagement with one of the roller guide 106 and the revolute joint assemblies 104. The first actuator 108 applies a force to one of the roller guide 106 and the revolute joint assemblies 104 to move one of the roller guide 106 and the revolute joint assemblies 104 along an axis defined by the output of the internal combustion engine 112.

By applying a force to the roller guide 106 using the guide actuator 108 to move the roller guide 106 axially along the primary axis A1, the amplitude of a torque generated by the variable inertia flywheel 100 can purportedly be adjusted to correct a torque ripple generated by the internal combustion engine 112. The amplitude of a torque generated by the variable inertia flywheel 100 is adjusted by changing a position of the roller guide 106 with respect to the revolute joint assemblies 104.

By moving the roller guide 106 axially along the primary axis A1 while the revolute joint assemblies 104 rotate within the roller guide 106, the radius of the revolute joint assemblies 104 can purportedly be controlled. In response to a change in the radius of the revolute joint assemblies 104, an average inertia of the revolute joint assemblies 104 also purportedly changes. Adjustment of a position of the roller guide 106 during operation of the internal combustion engine 112 using the controller is said to highly reduce torque ripples generated by the internal combustion engine 112, without concern for under-correction or over-correction.

Control of the amplitude of a torque generated by the variable inertia flywheel 100 is said to permit the variable inertia flywheel 100 to generate a higher inertia (through a greater radius of the revolute joint assemblies 104) at lower operating speeds of the internal combustion engine 112, and a lower inertia (through a smaller radius of the revolute joint assemblies 104) at higher operating speeds of the internal combustion engine 112.

### BRIEF DESCRIPTION OF THE DRAWINGS

FIG. 1 is a graph (reproduced from U.S. 2014/0260777 (Versteyhe)) illustrating the torque output of an engine during a four stroke cycle.

FIG. 2 is an illustration of a prior art torque compensator device.

FIGS. 3-4 are illustrations of a prior art torque compensator device from U.S. 2014/0260777 (Versteyhe).

FIG. 5 is a graph of engine torque as a function of engine speed (in RPMs) and some associated physical relationships.

FIG. 6 is a rear view of a first particular, non-limiting embodiment of an engine equipped with a pulse compensator in accordance with the teachings herein.

FIG. 7 is a side view of the pulse compensator of FIG. 6.

FIG. 8 is a perspective view of the pulse compensator of FIG. 6.

FIG. 9 is a side view of a four-bar input crank utilized in the pulse compensator of FIG. 6.

FIG. 10 is a front view of a four-bar input crank utilized in the pulse compensator of FIG. 6.

FIG. 11 is a perspective view of a four-bar input crank utilized in the pulse compensator of FIG. 6.

FIG. 12 is a side view of a four-bar follower crank utilized in the pulse compensator of FIG. 6.

FIG. 13 is a front view of a four-bar follower crank utilized in the pulse compensator of FIG. 6.

FIG. 14 is a perspective view of a four-bar follower crank utilized in the pulse compensator of FIG. 6.

FIG. 15 is a side view an of a four-bar coupler link utilized in the pulse compensator of FIG. 6.

FIG. 16 is a side view an of a four-bar coupler link utilized in the pulse compensator of FIG. 6.

FIG. 17 is a graph of the torque pulse cancellation properties of a four-bar pulse compensator in accordance with the teachings herein.

FIG. 18 is a free body diagram and simple bond graph model of a prior art diesel engine equipped with a fly wheel.

FIG. 19 is a simple bond graph model of a particular, non-limiting embodiment of a system in accordance with the teachings herein.

FIG. 20 is a schematic illustration of a cylinder used to derive torque output.

FIG. 21 is a graph of simulated torque output due to non-combustion forces in one cylinder.

FIG. 22 is a graph of simulated torque output due to combustion forces in one cylinder.

FIG. 23 is a graph depicting simulated torque output due to combustion forces in a single cylinder.

FIG. 24 is a graph of simulated overall torque due to one cylinder.

FIG. 25 is a graph of the computationally derived ideal torque output of a linkage diesel engine.

FIG. 26 is an illustration of the notation used herein for the development of four-bar linkage dynamic synthesis.

FIG. 27 is an illustration of a simplified four-bar linkage utilized for modeling purposes herein.

FIG. 28 is a graph of the linkage geometry simulation of a mechanism with optimized torque characteristics.

FIG. 29 is a graph of ω₃ for the optimized mechanism.

FIG. 30 is a graph of α₃ for the optimized mechanism.

FIG. 31 is a graph of the g function of balancing mass.

FIG. 32 is a graph of the h function of balancing mass.

FIG. 33 is a graph of the gh product of balancing mass.

FIG. 34 is a graph of the resultant torque of four-bar and optimal torque.

FIG. 35 is a graph depicting engine torque, average torque and cancelled torque.

FIG. 36 is a graph of average torque generated by diesel engine as a function of crankshaft operating speed.

FIG. 37 is a graph depicting the % torque variation that passes through the four-bar mechanism as a function of operating speed.

FIG. 38 is a graph depicting the % torque variation that passes through the four-bar mechanism as a function of operating speed in the optimal range.

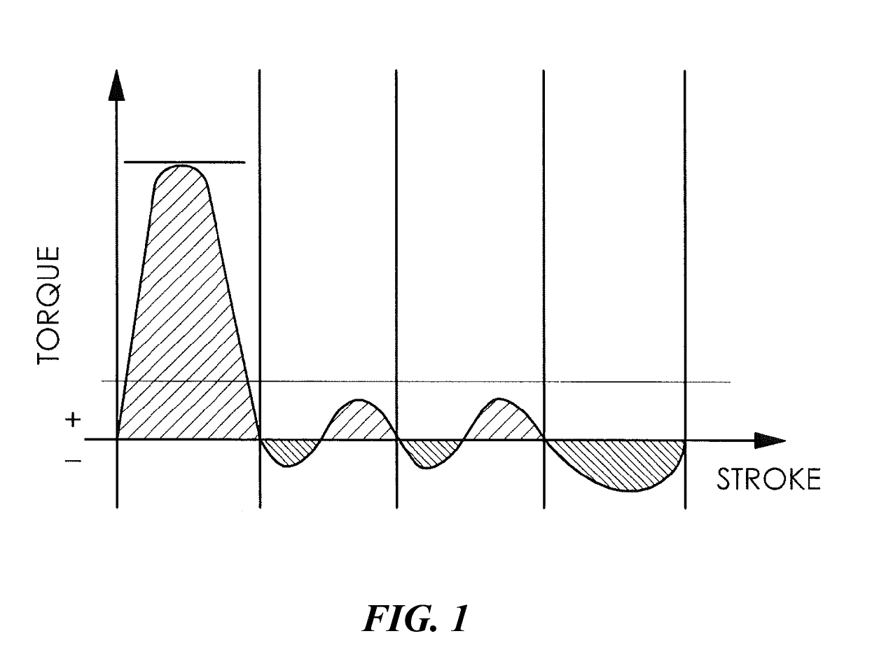

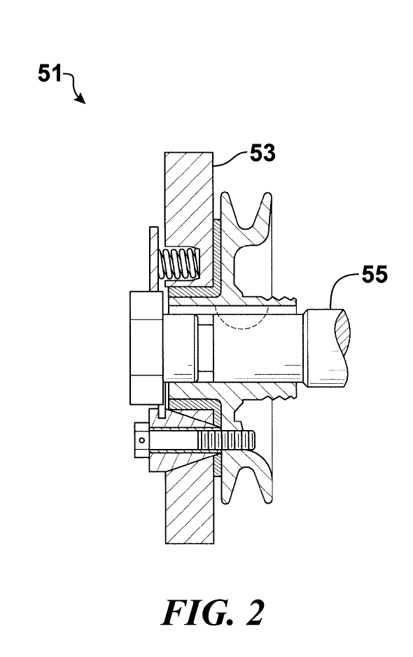

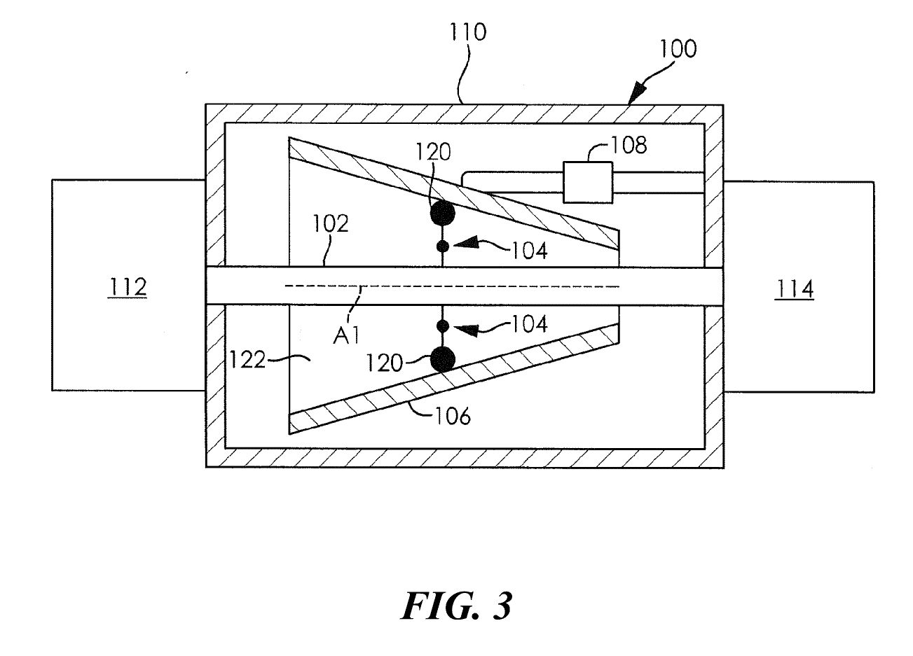

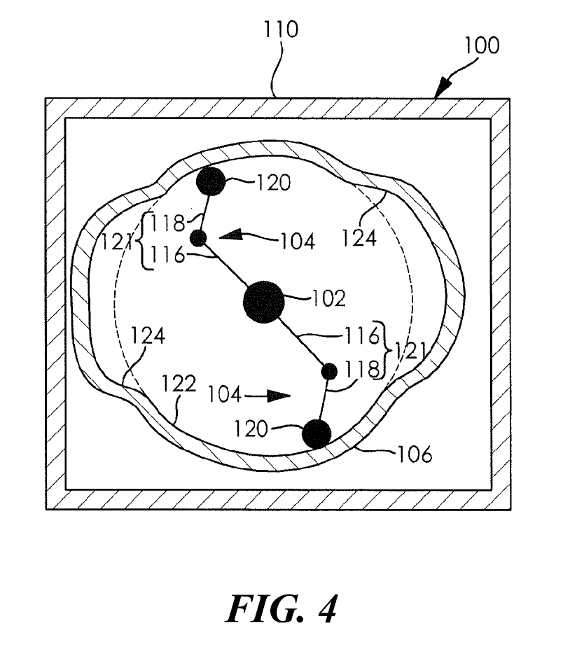

SUMMARY OF THE DISCLOSURE

In one aspect, an engine and gear train combination is provided which includes an engine which drives a first crankshaft having a first gear disposed thereon; a second crankshaft having a second gear and a flywheel disposed thereon, wherein said second gear meshes with said first gear; and a pulse compensator having a central element which is pivotally connected on a first end thereof to a first set of lateral members and which is pivotally connected on a second end thereof to a second set of lateral elements. Each element of the first set of lateral elements is also pivotally connected to the second crankshaft, and each element of the second set of lateral elements is pivotally connected to a mount.

In another aspect, a driveline is provided which comprises (a) an engine; (b) a first rotary mass; and (c) a non-linear inertia torque generator disposed between said engine and said rotary mass, wherein said torque generator is equipped with a second mass which is movably disposed on a radius, and an actuator which adjusts the inertia of the torque generator by moving said second mass along said radius.

In a further aspect, a method is provided for varying the compensation for torque ripple with speed in a driveline. The method comprises (a) providing a driveline which includes (i) an engine, (ii) a first rotary mass, (iii) a non-linear inertia torque generator disposed between the engine and the rotary mass, and (iv) a second mass which is repositionable on a radius, wherein the inertia of the torque generator varies with the position of the second mass on the radius; (b) determining the speed at which the engine is operating; (c) determining a desired inertia for the torque generator at the determined speed; and (d) adjusting the position of the second mass on the radius to achieve the desired inertia.

### DETAILED DESCRIPTION

At present, considerable resources are being spent to improve the operation, fuel efficiency and safety of highway truck tractors, while also reducing their cost. It is generally accepted that a 4-cylinder diesel engine operating at lower RPMs will be more fuel efficient, since its operation entails less lube churning and velocity-induced friction. Unfortunately, as noted above, 4-cylinder engines produce higher torque pulses twice for each revolution. This requires the use of larger flywheels and more sluggish speed/shifting sequences. Moreover, the flywheel passes on some pulse harmonics to the driveline, where the transmission and differentials suffer wear damage. Finally, the 4-cylinder engine must produce proportionately higher torques at lower RPMs, which merely exacerbate the foregoing issues.

For example, during hill climbing, the final transmission torque may be 10 to 20K ft-lb., which is extremely high for a driveline and the components thereof (such components may include, for example, the bearings, gearing, and torque spikes). Such torques can typically only be handled by heavier components, which increases the weight of the gear train. Moreover, it has been found that these torque levels can actually twist the frame of the tractor, thus inducing a tendency in the right-rear tire(s) to slip and wear more rapidly. Hence, the adoption of lower RPMs and high torque engines raises several issues. While the devices of U.S. 2014/0260777 (Versteyhe) may have some desirable attributes, they fail to adequately address these issues.

It has now been found that these issues may be addressed by the drivelines disclosed herein, and the systems, devices and methodologies associated with them. In a preferred embodiment, these drivelines incorporate a mechanical system (preferably in the form of a four-bar linkage) that produces highly nonlinear inertial and torque characteristics through its cycle of operation, even at constant speed. The resulting system may be implemented with the optimal geometry and mass content necessary to mechanically balance the non-linear torque pulses of an engine. The optimized mechanism derived may allow an RMS deviation from a perfectly constant torque output which is less than 5% of the deviation from this RMS average of the engine by itself.

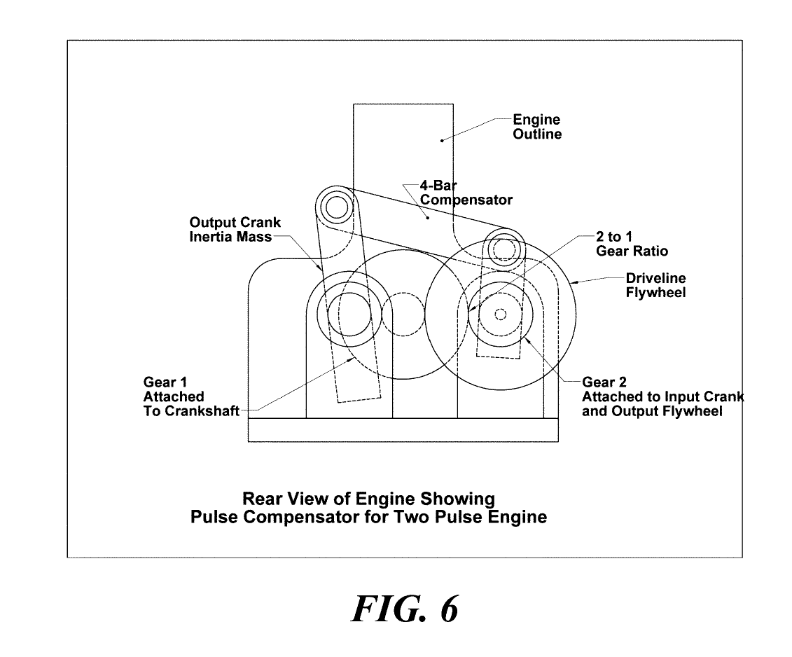

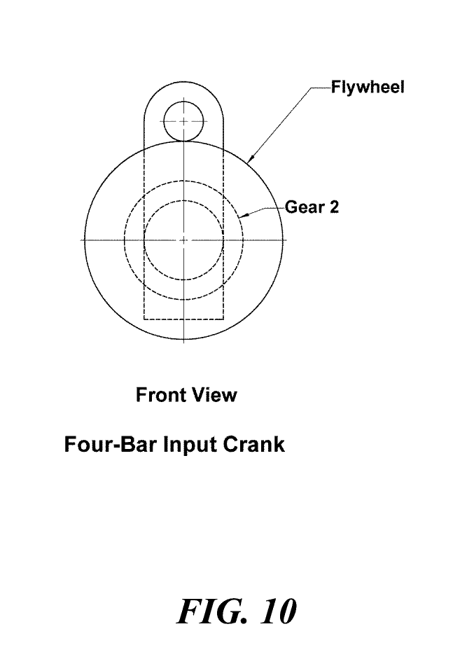

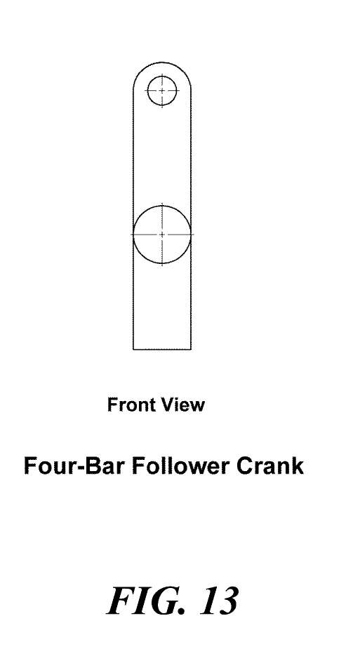

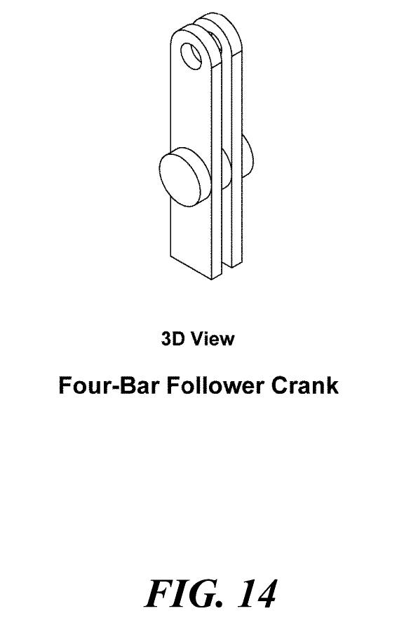

The drivelines disclosed herein, and the associated systems, devices and methodologies utilizing them, may be understood with reference to FIGS. 6-15, which depict a first particular, non-limiting embodiment of an engine and gear train assembly equipped with a pulse compensator in accordance with the teachings herein. As best seen in FIG. 6, the engine and gear train assembly 201 includes an engine frame 203 or outline within which is disposed an engine (not shown) that drives a crankshaft 205. The crankshaft 205 has a first gear (Gear 1) 207 disposed thereon which meshes with a second gear 209 (Gear 2), preferably at a 2-to-1 gear ratio. The second gear 209 is disposed on an input crankshaft 211, and is attached to a flywheel 213.

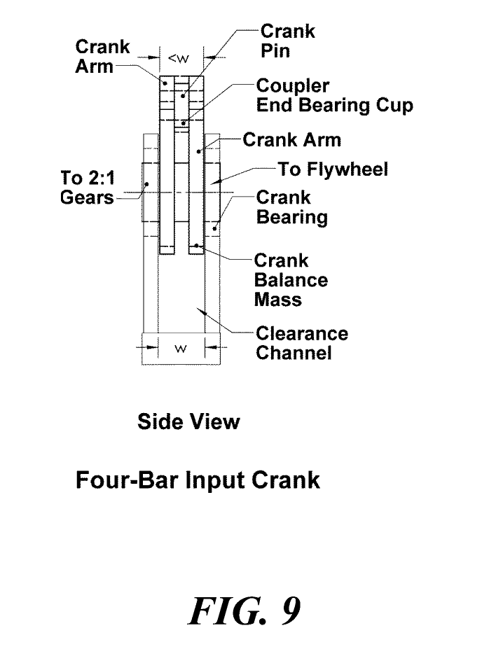

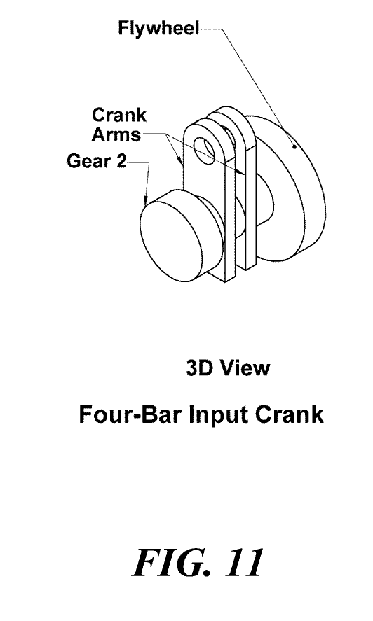

The engine and gear train assembly 201 further includes a 4-bar pulse compensator 215 comprising a coupler link 217 (see FIG. 6) having first 219 and second 221 sets of crank arms pivotally attached to respective first and second opposing ends thereof by way of first 223 and second 225 respective crank pins. The first set of crank arms 219 is pivotally attached to the input crankshaft 211 (see FIG. 11) between the second gear 209 and the fly wheel 213, and the second set of crank arms 221 is pivotally attached to follower crankshaft 227 (see FIG. 9).

As seen in FIG. 9, the first set of crank arms 219 is disposed between opposing mounts 231. The mounts 231 define a clearance channel 235 whose width is slightly greater than the combined width of the first set of crank arms 219, and whose height slightly exceeds the distance from the center of the input crankshaft 211 and the tips of the first set of crank arms 219. The first set of crank arms 219 is further equipped with a coupler end bearing cup 241 adjacent to first crank pin 223, and a crank bearing 243 adjacent to input crankshaft 211.

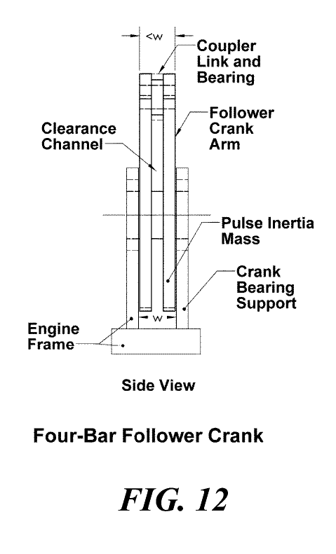

Similarly, as seen in FIG. 12, the second set of crank arms 221 is disposed between opposing mounts 251. The mounts 251 define a clearance channel 255 whose width is slightly greater than the combined width of the second set of crank arms 221, and whose height slightly exceeds the distance from the center of the pivot 257 and the tips of the second set of crank arms 221. The second set of crank arms 221 is further equipped with a coupler end bearing cup 261 adjacent to second crank pin 225, and a crank bearing 263 adjacent to pivot 257.

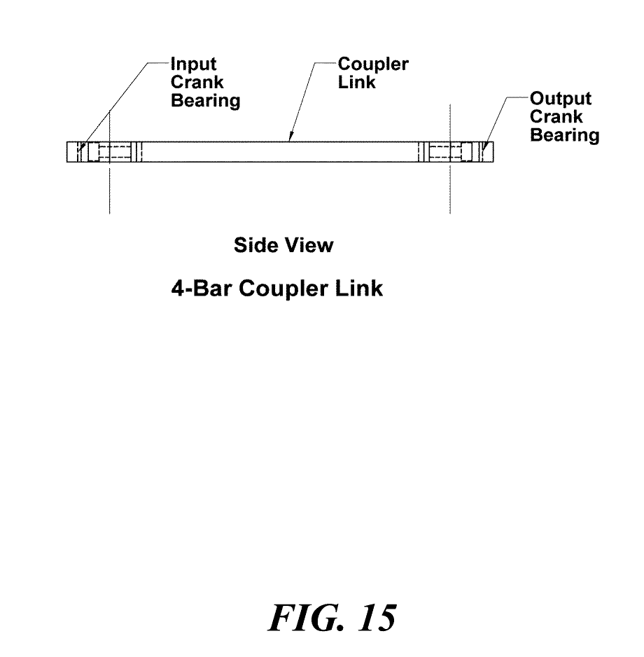

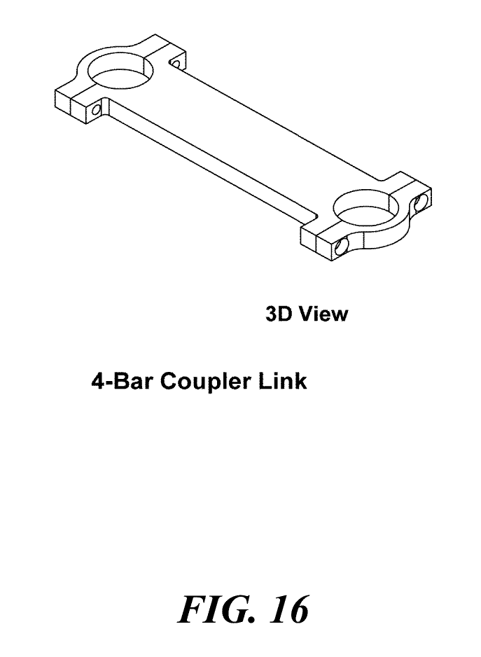

The design of the coupler link 215 may be further appreciated with respect to FIGS. 15-16. As seen therein, the coupler link 215 is equipped with first 271 and second 273 apertures through which follower crankshaft 227 and pivot 257 extend, respectively. These apertures have associated input 275 and output 277 crank bearings, respectively.

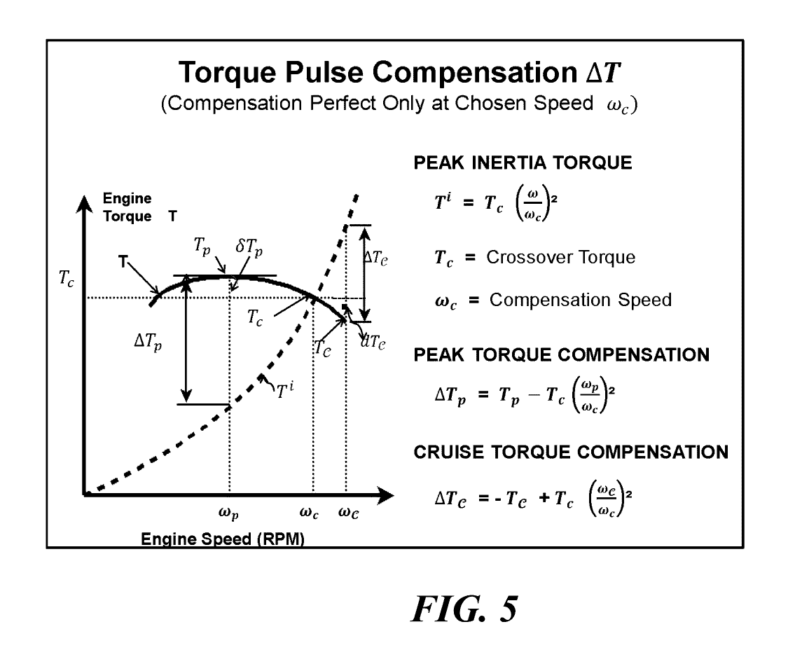

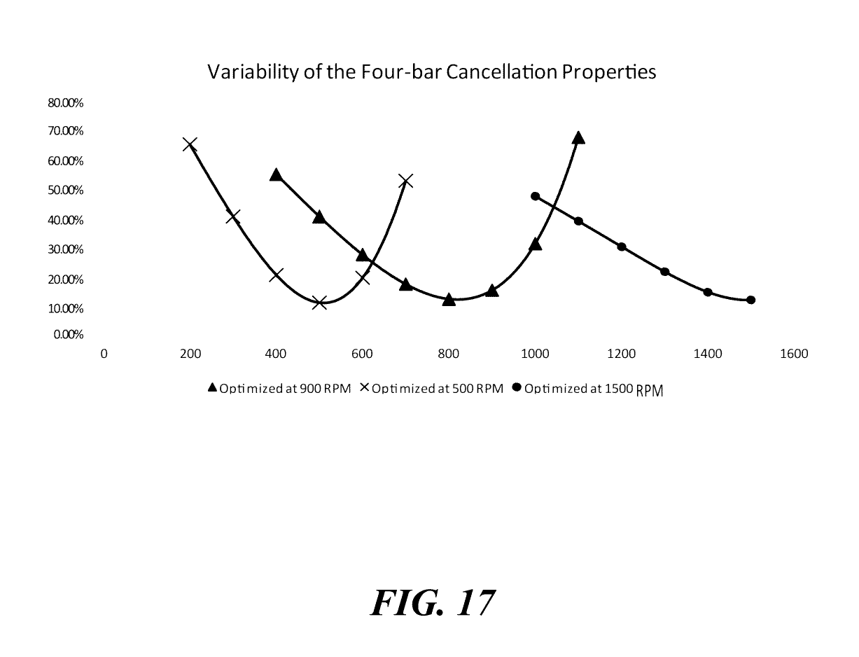

FIG. 17 depicts the torque ripple cancellation properties of a 4-bar pulse compensator of the type depicted in FIGS. 5-10, when optimized for speeds of 500 RPM, 900 RPM and 1500 RPM. As seen therein, the device may be utilized to achieve torque compensation over a wide range of speeds (e.g., 500-1500 RPM). In the particular, non-limiting embodiment giving rise to the depicted results, this was achieved with a 12% RMS residual relative to the average pulse torque of the engine. The primary pulse compensation came from the rotary mass Ī (e.g., flywheel 213) attached to the output link of the 4-bar linkage. The geometry of the linkage was carefully chosen to provide a close match of the negative inertia torque to the positive engine pulse torque enabling a very good cancellation resulting in a 12% residual as a difference of the two curves.

A simple change in the effective inertia Ī on the output link of the 4-bar may be utilized to cause the system to perform the same pulse compensation at various speeds. The 4-bar pulse compensator is unusually rugged, represents no (or essentially n) energy losses, and is lightweight and relatively small. It attaches in parallel to the output crank of the engine. To vary the speed and, therefore, the compensation torque then requires modifications to the effective value of the output inertia Ī. This may be accomplished with concentration of mass M̅ constrained in a slider whose center line passes through the output crank pivot of the 4-bar, structurally offset from the output pin joint of the 4-box. A linear actuator may then be utilized to move that mass along the radius line from the pivot to make the required changes in Ī.

The foregoing approach has been tested for speeds of 500, 800 and 1500 RPM, with the results shown in the graph of FIG. 17. In each case, the residual is approximately 12%. This demonstrates the feasibility of a torque sensor to measure the actual peak torque in order to adjust the inertia value Ī in real time, thereby always maintaining the best residual in concert with a measured speed for the 4-bar pulse compensator over a wide range of speeds.

The pulse compensator disclosed herein may be utilized to achieve new and highly advantageous driveline architectures. For example, in a preferred embodiment for tractor trailers, these architectures meet the following basic parameters:

(a) A total of 30,000 ft-lb. torque on all four tractor wheels to meet a 15% grade climbing target at a reasonable speed;

(b) A total of 4,000 ft-lb. torque on all four tractor wheels at cruise speed and a 1% grade.

(c) An engine torque of 2000 ft-lb. at 900 RPM to match a benchmark vehicle speed of 60 mph.

(d) Normal braking is the inverse requirement to hill climbing when going downhill. Emergency braking needs to be given serious consideration with “locking” torques at the wheels and not borne by the drive line.

(e) Reduction in the effects of engine pulses, clutch shocks, and hitching shocks by introducing multiple shock filters in the driveline design.

In a preferred embodiment, the torque compensator described herein features a non-linear inertia torque generator which is disposed between the engine and the flywheel. This inertia generator is in the form of a 4-bar linkage having an output link which carries a sufficient mass to create an inverse pulse to that created by the combustion forces in the engine. This torque pulse cancellation is designed to work “perfectly” at a single chosen engine speed ω_{c}, which may be chosen to be between the peak torque speed ωₚ and the cruise speed ω_{c} (see FIG. 5) of the vehicle. The compensation is then less by ΔTₚ at peak torque speed, as indicated in EQUATION 1:

$$Δ {T}_{p} = {T}_{p} - {{T}_{c} ( \frac{{ω}_{p}}{{ω}_{c}} )}^{2} \qquad ( EQUATION 1 )$$

and greater than ΔTₑ at the cruise speed, as indicated by EQUATION 2:

$$Δ {T}_{C} = - {T}_{C} + {{T}_{c} ( \frac{{ω}_{C}}{{ω}_{c}} )}^{2} \qquad ( EQUATION 2 )$$

The peak torque Tₚ of the engine at peak torque speed ωₚ, and the cruise torque T_{C} at cruise speed ω_{C} (using a pulse compensation torque T_{c} at compensation speed ω_{c}) determine the resulting values for ΔTₚ and ΔT_{C}, which then become residual torque pulses passed on to the flywheel. Using numbers such as:

Tₚ=2000 ft-lb., ωₚ=900 RPM

T_{c}=1800 ft-lb., ω_{c}=1000 RPM

T_{C}=1600 ft-lb., ω_{C}1100 RPM

results in pulse compensation residuals of less than 30%, which means that 70% or more of pulse is removed between speeds ωₚ and ω_{C}. This demonstrates that torque pulse compensation can only occur perfectly at one engine speed ω_{c}, such that ΔT_{c}≡0. When the engine slows, the engine torque rises to Tₚ, the peak torque, while the compensating inertia drops by the square of the speed to result in incomplete torque compensation residual of ΔTₚ. The same situation occurs at cruise when the engine torque pulse drops to T_{C} while the compensating inertia torque rises by the square of the speed to leave a torque compensation residual of ΔT_{C}. Hence, the differences Δω=ω_{C}−ωωₚ and ΔT=Tₚ−T_{C} all have a significant impact on torque compensation.

In the preferred embodiment, the crank of the 4-bar is driven at twice the speed of the two pulse crankshaft in order to create two inverse pulses for each crankshaft rotation. For example, for an engine speed of 1000 RPM, the 4-bar is preferably driven at 2000 RPM. This requires a gear ratio of 2-to-1 between the crankshaft and the 4-bar input crank. Consequently, the flywheel operates at 2000 RPM instead of 1000 RPM. Since it faces 70% less pulse torque and operates at twice the speed, it can now be 13× less in effective inertia, which is a dramatic reduction in actual weight. Of course, the 4-bar and gear reducer add weight, so the probable weight benefit is about 3 to 5×.

Other benefits may be achieved with the foregoing embodiment as well. The output torque is reduced by 2× because of the 2× increase in flywheel speed. For example, the average peak engine torque may be 2000 ft-lb., such that the peak flywheel torque becomes 1000 ft.-lb. This results in a much lighter driveline, which is necessarily less stiff to act as a shock filter on the rest of the driveline components.

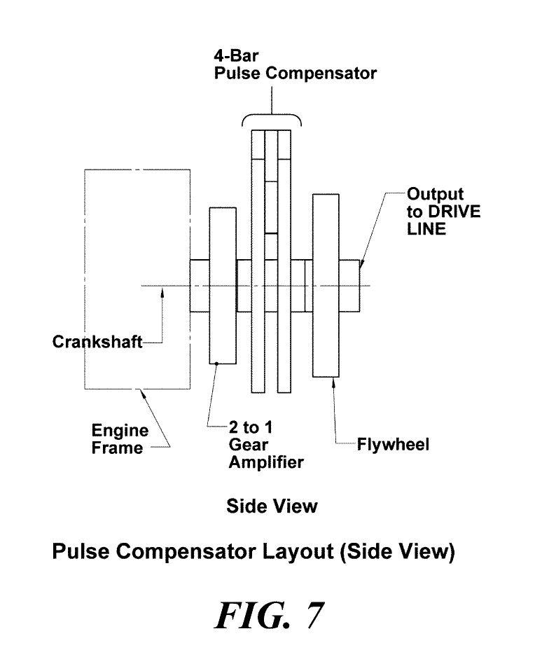

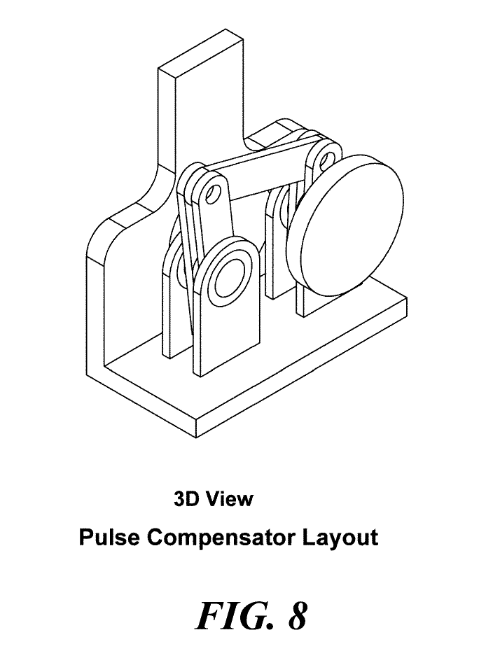

FIGS. 7-8 shows the sequential planes for the 2-to-1 gear amplifier, the 4-bar pulse compensator 215 linkage, and the flywheel 213, and FIGS. 9-16 provide feasible structural layouts of the three moving links and the suggested crankcase support structure. Note that the follower output crank (the second set of crank arms 221) of the 4-bar linkage should preferably carry considerable inertia to create the required inertia torque pulses. This type of linkage is preferably dimensioned to ensure that the ratio of the minimum/maximum inertia torques closely match those minimum/maximum values of the engine pulses. Also, all non-linear mechanisms are preferably shaking force balanced (a simple algebraic procedure), and their inertia shaking moments are preferably reduced by judicious distribution of all moving link masses.

The gear train assemblies disclosed herein may be utilized to create the lightest, most efficient transfer of power from the flywheel to the wheels. While electrically-driven hub drive wheels might be utilized for this purpose, such an approach is limited as a practical matter to applications such as fleet vehicles, buses, and light passenger vehicles. However, for cross-country trucks, the multiple energy transfers (engine, generator, battery, and drive motor) inherent in this approach represent significant and unacceptable energy losses.

The hub drive motor offers the benefits of positive/negative wheel torque for traction control for enhanced safety (torque vectoring) and improved efficiency. In a preferred embodiment, direct driveline torques are utilized to multiple disk clutches to a 2 to 4-speed hub drive wheel with no energy transforms, and in which the primary control is offered by slip clutches in front of the multi-speed hub wheel drive gear trains.

In a preferred embodiment, 1000 ft-lb. of torque will pass through 1-to-1 differentials to the 250 ft-lb. capacity slip clutches on each wheel. The driveline rpm (which may be, for example, 2000 RPM) and torque (which may be, for example, 1000 ft-lb.) will be maintained until the power reaches each slip clutch at 2000 RPM and 250 ft-lb. This means that the hub drive wheels should offer a range of four speeds in each wheel with reduction ratios of 21-to-1 down to 4-to-1. The backend module preferably has the cross-roller bearing in a shortest force path between the wheel and the rugged gear train backbone. This module preferably utilizes three (or possibly 4) star gears to drive a large diameter internal gear to provide a fixed 4-to-1 reduction ratio with exceptional durability.

The drive train is then preferably made up of a high-speed/low-torque front end 2-speed module (very low inertia/weight) which is normally labeled an inverted star compound. The mid-module of higher torque and lower speed would be a direct drive star compound offering two speed ratios. Each two-speed module would use a synchro mesh clutch operated by servos stored in the free volume of the backend 4-to-1 module. A feasible selection of module reductions is given in TABLE 1 below.

TABLE 1
Module Reductions

| Stage Reductions | Overall Reductions |
|---|---|
| 4, 3, 1.75 | 21 to 1 |
| 4, 3, 1 | 12 to 1 |
| 4, 1, 1.75 | 7 to 1 |
| 4, 1, 1 | 4 to 1 |

The foregoing values provides some indication of the potential four reductions at the drive wheel.

In the preferred embodiment, each hub drive train is preferably connected to the driveline through a 250 ft-lb. slip clutch. The transferred torque may be in the range of 0 to 250(+) ft-lb., which gives the clutch the effective positive torque of an electric motor drive. If each clutch may also be disconnected from the drive line and its housing brake, then it may offer a controlled (negative) braking torque. Given a hub reduction of 21-to-1, this 250 ft-lb. of torque may be magnified to 5,250 ft-lb. at each wheel. Given that other wheels on the truck can also brake, then a 0.5 g controlled stop may be feasible.

Also, at 21-to-1 in the low speed regime, a negative stopping torque may lock up the drive train to result in an emergency stop. Note also that at 21-to-1, the 5,250 ft-lb. per wheel (or 21,000 ft-lb. for the whole vehicle) torque is approaching the desired 30,000 ft-lb. for hill climbing at a reasonable speed. The 4-to-1 reduction would offer 4,000 ft-lb. total for the vehicle at cruise speed and a 1% grade. A 42″ wheel diameter and a maximum flywheel speed of 2000 RPM would provide the upper range vehicle speeds and associated maximum torques given in TABLE 2 below.

TABLE 2
Vehicle Speeds and Associated Torques

| | Road Speed | Wheel Torque |
|---|---|---|
| Reduction | (mph) | (ft-lb.) |
| 4 to 1 | 62.5 | 1,000 |
| 1 to 1 | 35.7 | 1,750 |
| 12 to 1 | 20.8 | 3,000 |
| 21 to 1 | 11.9 | 5,250 |

One advantage of the clutched wheel drives described herein is that any 2, 3, or 4 of them may be engaged at one time to maximize efficiency or drive torque or braking effectiveness. Further, suppose that the first differential increases the output speed by 10% while reducing torque by 10%, while the second differential reduces the output speed by 10% while increasing the output torque by 10%. This essentially doubles the operational choices. Every wheel represents four speed/torque choices (or 16, altogether). Every wheel may be operational or in neutral for four more choices. Considering a full combination, this represents 128 choices.

Further, each pair of wheels on an axle may be utilized for torque vectoring by braking one side and driving the other to improve stability in poor road or weather conditions. Given torque sensing on each wheel, the slip clutch/brake combination may also be used to best match drive-torque to available road/wheel traction conditions.

The question of emergency braking suggests a high demand for maximum torque at the drive wheel slip clutch. Suppose that the four drive wheels are to provide 50% of the stopping force for the tractor/trailer vehicle which weighs 80,000 pounds. This means that the braking torque per wheel for a 1 g stop would be 17,500 ft-lb., or 4,375 ft-lb. on each braked clutch. This appears to be very demanding (i.e., 17.5× higher than its designed operating torque).

A question also arises with the use of friction cone synchro clutches. Each clutch would be servo controlled. Each clutch must accelerate or decelerate the rotary mass between the slip clutch and itself. It is feasible to use Clutch 2 (near the wheel) to accelerate/decelerate the rotary mass between it and Clutch 1 by putting Clutch 1 in neutral during the shift, which would reduce demands on Clutch 2. Then, Clutch 1 would have to do the same for lower rotary mass between it and the multi-disk slip clutch. Note that the slip clutch inertia may be a significant additional rotary inertia faced by Clutch 1. This suggests that Clutch 1 should be least used, and that Clutch 2 should be used first when making speed changes.

There is some concern about the climbing speed needed for a 15% grade. The required torque is 30,000 ft-lb. To achieve this torque, a total reduction from 2000 RPM to 64 RPM is required at the wheel. This suggests the ratios for each stage set forth in TABLE 3.

TABLE 3
Stage Ratios

| Stage 3 | Stage 2 | Stage 1 | Total | Speed (mph) |
|---|---|---|---|---|
| 3.5 | 1 | 1 | 3.5 | 71 |
| 3.5 | 2 | 1 | 7.0 | 35.5 |
| 3.5 | 1 | 4.5 | 15.75 | 15.8 |
| 3.5 | 2 | 4.5 | 31.5 | 8 |

The foregoing creates the valid question as to whether these are good ratio selections relative to the acceptable road speeds. However, with 128 unique operating configurations available, it is recommended that the engine be operated as much as possible at its efficiency/torque/power sweet spot. This requires that a decision structure be put in place to automatically choose the best configuration to maintain this sweet spot target objective. The operator may set guidance such as: it is hot, wet, cold, windy, icy, raining, be careful, etc. Then, the decision structure would select the best options available to meet this guidance. Doing so would also allow the pulse compensator to be tuned to this sweet spot objective in order to best cancel the engine pulses, perhaps up to a 90% better cancellation.

Finally, there is concern for emergency braking, since a 1 g stop would require three seconds and 150 ft. To do so would require 14,000 ft-lb torque per axle for a 80,000 lb. fully loaded vehicle. This is 7,000 ft-lb. per wheel, or ≈17× more torque than can be provided by the clutch at 250 ft-lb and a 3.5 to 1 reduction ratio when traveling at full cruise speed. Infrequently used emergency brakes may be used to augment enhanced slip clutch braking under less demanding braking conditions (i.e., when operating at lower speeds and higher reduction ratios). This means that friction drum brakes would only be used in the most demanding situations when stopping from high speed or on poor road surfaces.

The principles disclosed herein and described above may be further appreciated and illustrated by a more in depth consideration of the origins of torque ripple, and how torque ripple may be addressed with the systems, devices and methodologies disclosed herein.

Consider a truck cruising at highway speed with constant velocity or accelerating from rest or some lesser or greater speed. The application of a driving torque, T_{Out}, generated by the latent chemical energy of a fuel source (e.g., diesel fuel), is utilized to change the momentum of the truck (acceleration), or to overcome (at constant velocity) energy losses associated with mechanical friction. Such energy losses may include, for example, frictional losses arising from viscous fluid friction or heat transfer.

A general characteristic of combustion engines of any type (see, e.g., Ramstedt, Magnus. “Cylinder-by-Cylinder Diesel Engine Modeling—A Torque-based Approach.” Vehicular Systems. Web. 18 Jun. 2004) is that the fewer cylinders the engine has, the more non-linear its torque output characteristics become. In particular, the output becomes more sinusoidal as the number of cylinders increases, which remains less then optimal. As noted above, this is currently managed in industry by the use of a flywheel of large rotational inertia, I_{flywheel}, which acts to resist changes in angular speed via its polar moment of inertia about the crankshaft axis to which it is mounted. Assuming a simple solid disk is acting as the flywheel, this rotational inertia, I_{flywheel}, is given by

$${I}_{flywheel} = \frac{1}{2} {m}_{fly} {r}_{fly}^{2} \qquad ( EQUATION 3 )$$

More complex geometries remain linearly proportional to the mass of the flywheel.

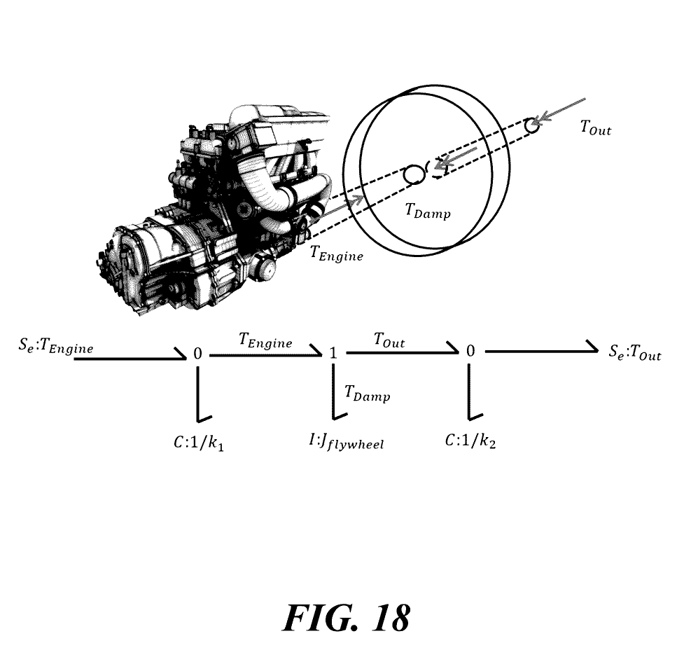

Systems with larger torque smoothing demands require proportionally more massive flywheels. Adding more mass to the system adds more energy demand to the engine, thus leaving less useful energy available to responsively drive the vehicle. The four-bar linkage has many more parameters that contribute to its compensating torque, which is inherently non-linear. This non-linearity may be exploited to generate a desired torque curve, without adding too much mass to the system. The flywheel may only act to absorb and release energy in response to changes in crankshaft speed (that is, it may behave as a passive inertia element from a systems point of view). The non-linearity of the four-bar torque may allow for the attainment of a much smoother torque output of the engine with a much smaller inertial content then is possible with the flywheel, the latter of which can only damp (not cancel) torque oscillations. The general system model as it exists now is shown in FIG. 18 in free body and bond graph form.

The bond graph model utilized here is sufficiently detailed for the present purpose, which is the derivation of EQUATION 4 below, which may be found from the summation of torques about the axis of rotation utilizing Euler's form of Newton's Third Law, or from summing the torques at the 1 junction of the bond graph model. This controlling equation is then given by:

T_{Engine}=T_{Out}+T_{Damp} (EQUATION 4)

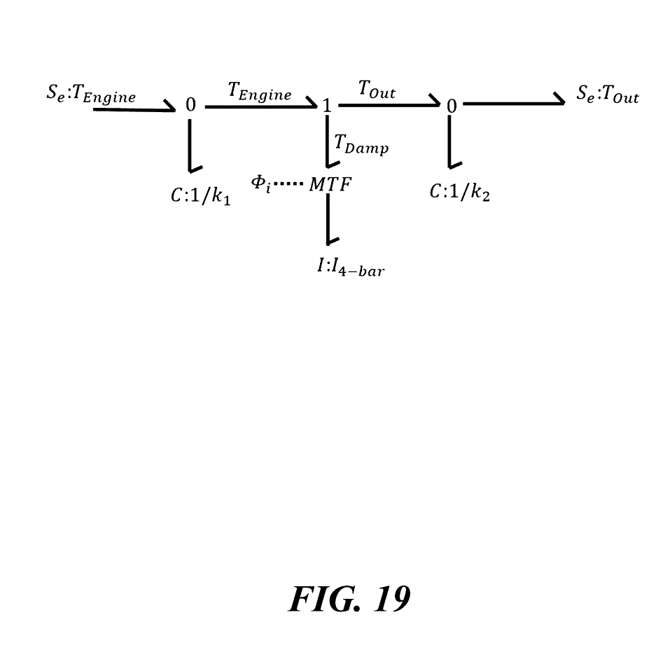

It has been found that the traditional method of creating T_{Damp} through a flywheel induces unnecessarily large mass content in a system with large torque smoothing requirements. A more optimal T_{Damp} is disclosed herein that creates a more linear output post mechanism, while adding far less mass content due to the non-linear nature of the driving mechanism. As noted above, the update to the system proposed herein entails the replacement of flywheel torque with four-bar torque. This updated system is depicted in simplistic fashion in the bond graph model of FIG. 19. In this case the simple inertance has been replaced by a modulated transformer element. This element is modulated by the input angle Φᵢ. As seen below, this choice of modulation signal arises from the mathematical derivation of the four-bar torque, and is appropriate, as all system kinematics and dynamics are found to be a pure function of Φᵢ for any given geometrical configuration.

In order to better illustrate the advantages of the systems and methodologies disclosed herein, it is advantageous to first consider a suitable modeling and simulation of diesel engine torque. The first stage of this approach involves the simulation of the pulse output of a four-cylinder diesel engine. The full development from first principles of the analytical model presented and utilized herein may be found in Ramstedt, Magnus. “Cylinder-by-Cylinder Diesel Engine Modeling—A Torque-based Approach.” Vehicular Systems. Web. 18 Jun. 2004. The model is developed for the torque output of a single cylinder over 720° of crankshaft rotation. Two full revolutions are necessary to encompass all four strokes of the engine, that is, intake, compression, combustion, and exhaust. Different analytical descriptions describe the dynamics of each stroke, for one piston. Once the model is developed for a single piston, it is repeated every 180° of the 720° cycle to achieve a model of the torque output which is based on engine parameters.

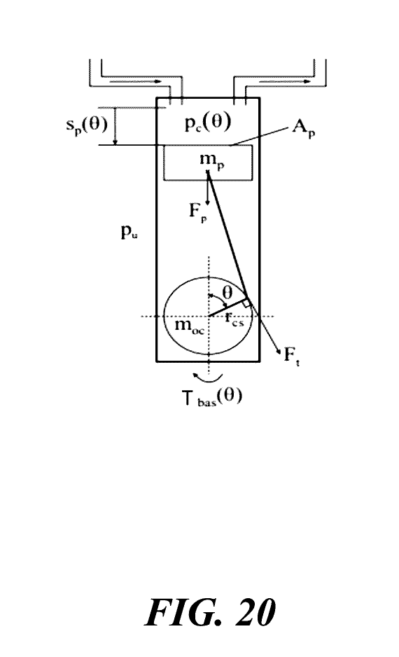

A physical layout of a cylinder with the parameters used in the development of the model is depicted in FIG. 20.

The torque created by one piston is due to two processes; the combustion of fuel which, when combined with heat losses at the wall, causes an effective torque, T_{eff}, and the mass and pressure forces not associated with the combustion process, which cause a “basic torque” T_{bas}. The resultant piston torque T_{cyl} is then the sum of these two.

Considering first the non-combustion torque, T_{bas}, the torque output is derived with respect to the crankshaft angle, θ. The gas pressure within the cylinder is unique for the intake stroke, θ ∈ [0°, 180°], the compression and combustion stroke, θ ∈ [180°, 540°], and the exhaust stroke, θ ∈ [540°, 720°]. This piecewise relation is given by:

$${p}_{Bas} ( θ ) = \{ \begin{matrix}{p}_{c , int} ∀ θ ∈ [ 0 ° , 180 ° ] \\ {p}_{c , bcp} ( \frac{{V}_{c , bcp}}{{V}_{c} ( θ )} ) ∝ ∀ θ ∈ [ 180 ° , 540 ° ] \\ {p}_{c , exh} ∀ θ ∈ [ 540 ° , 720 ° ]\end{matrix} \qquad ( EQUATION 5 )$$

The displacement of the piston from top dead center (TDC) is given by

$${s}_{d} ( θ ) = {r}_{cs} [ 1 - cos ( θ ) + \frac{{L}_{s / cr}}{4} ( 1 - cos ( 2 θ ) ) ] \qquad ( EQUATION 6 )$$

### Thus,

V_{c}(θ)=s_{d}(θ)Aₚ (EQUATION 7)

L_{s/cr} is the stroke to connecting rod ratio given by:

$${L}_{s / cr} = \frac{{r}_{cs}}{{l}_{cr}} \qquad ( EQUATION 8 )$$

V_{c,bcp} is the maximum volume of the cylinder which occurs at the beginning of the compression stroke, and ∝ is the polytropic exponent, a constant unique to every engine and determined empirically. The torque due inertia and intake and exhaust pressure differences over the full four strokes is given by the following piecewise formulation:

$$\begin{matrix}{T}_{bas} ( θ ) = \{ \begin{matrix}( \begin{matrix}{p}_{c , int} {c}_{1} ( θ ) + \\ {ω}_{eng}^{2} {c}_{2} ( θ ) + {c}_{3} ( θ )\end{matrix} ) {c}_{4} ( θ ) & ∀ θ ∈ [ 0 ° , 180 ° ] \\ ( \begin{matrix}{p}_{c , bcp} {c}_{1} ( θ ) + \\ {ω}_{eng}^{2} {c}_{2} ( θ ) + {c}_{3} ( θ )\end{matrix} ) {c}_{4} ( θ ) & ∀ θ ∈ [ 180 ° , 540 ° ] \\ ( \begin{matrix}{p}_{c , exh} {c}_{1} ( θ ) + \\ {ω}_{eng}^{2} {c}_{2} ( θ ) + {c}_{3} ( θ )\end{matrix} ) {c}_{4} ( θ ) & ∀ θ ∈ [ 540 ° , 720 ° ]\end{matrix} \\ where & ( EQUATION 9 ) \\ {c}_{1} ( θ ) = \{ \begin{matrix}{A}_{p} ( \frac{{V}_{c , bcp}}{{V}_{clear} + {A}_{p} {r}_{cs} [ 1 - cos ( θ ) + \frac{{L}_{s / cr}}{4} ( 1 - cos ( 2 θ ) ]} ) ∝ & ∀ θ ∈ [ 180 ° , 540 ° ] \\ {A}_{p} & else\end{matrix} \\ {c}_{2} ( θ ) = - ( {m}_{oc} + {m}_{p} ) {r}_{cs} ( cos ( θ ) + {L}_{s / cr} cos ( 2 θ ) ) \\ {c}_{3} ( θ ) = - {p}_{amb} {A}_{p} \\ {C}_{4} ( θ ) = {r}_{cs} sin ( θ ) ( 1 + \frac{{L}_{s / cr} cos ( θ )}{\sqrt{1 - {L}_{s / cr}^{2} {sin}^{2 ( θ )}}} ) & ( EQUATION 10 )\end{matrix}$$

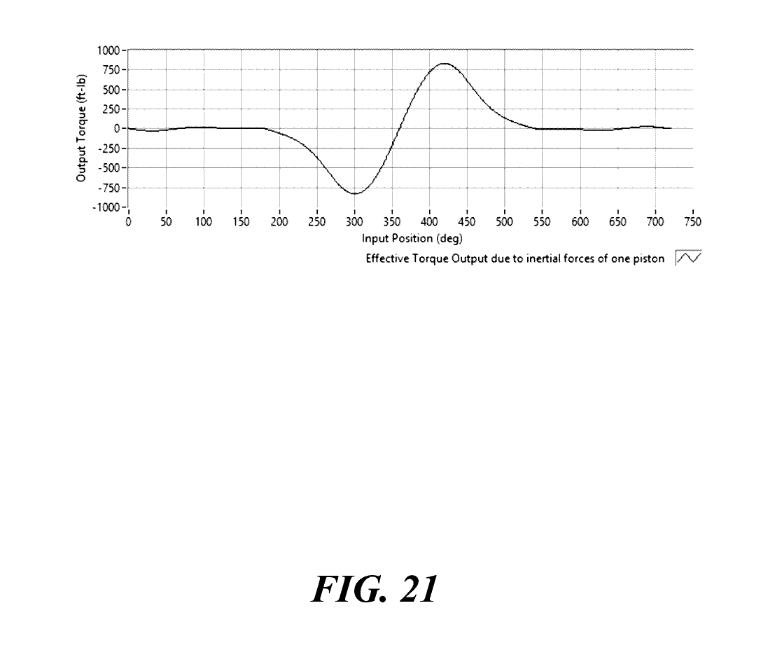

The torque created by non-combustion forces over the full four strokes is show in FIG. 21.

The torque created by combustion within the cylinder, T_{eff}, may be approximated by an analytical curve which matches measured experimental data. This expression is given by:

$$\begin{matrix}{T}_{bas} ( θ ) = \{ \begin{matrix}{a ( θ - 360 )}^{2} {e}^{( - b ( θ - 360 ) )} & ∀ θ ∈ [ 180 ° , 540 ° ] \\ 0 & else\end{matrix} \\ where & ( EQUATION 11 ) \\ a = \frac{4 \cdot 360 {\overline{M}}_{c , hp}}{{( {θ}_{max} - 360 )}^{3}} & ( EQUATION 12 ) \\ b = \frac{2}{{θ}_{max} - 360} & ( EQUATION 13 )\end{matrix}$$

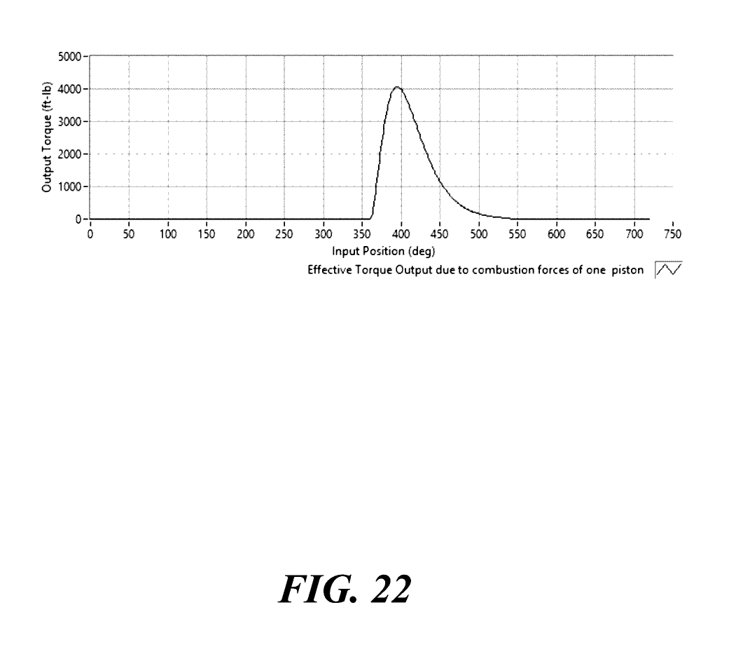

M̅_{c,hp} is the mean cylinder torque during combustion and is given by:

$${\overline{M}}_{c , hp} = \frac{30 {η}_{vol} {Q}_{HV} {\dot{m}}_{f}}{{ω}_{eng} π} \qquad ( EQUATION 14 )$$

where ηᵥₒₗ is the combustion efficiency, Q_{HV} is the fuel heating value, \dot{m}_{f} is the average mass flow rate, and ω_{eng} is the engine speed. This contribution is shown in FIG. 22.

The torque created by combustion within the cylinder, T_{eff}, may be approximated by an analytical curve which matches measured experimental data. The expression for this curve is given by EQUATION 15 below.

$${T}_{bas} ( θ ) = \{ \begin{matrix}{a ( θ - 360 )}^{2} {e}^{( - b ( θ - 360 ) )} & ∀ θ ∈ [ 180 ° , 540 ° ] \\ 0 & else\end{matrix} \\ where \\ a = \frac{4 \cdot 360 {\overline{M}}_{c , hp}}{{( {θ}_{max} - 360 )}^{3}} \\ b = \frac{2}{{θ}_{max} - 360} \qquad ( EQUATION 15 )$$

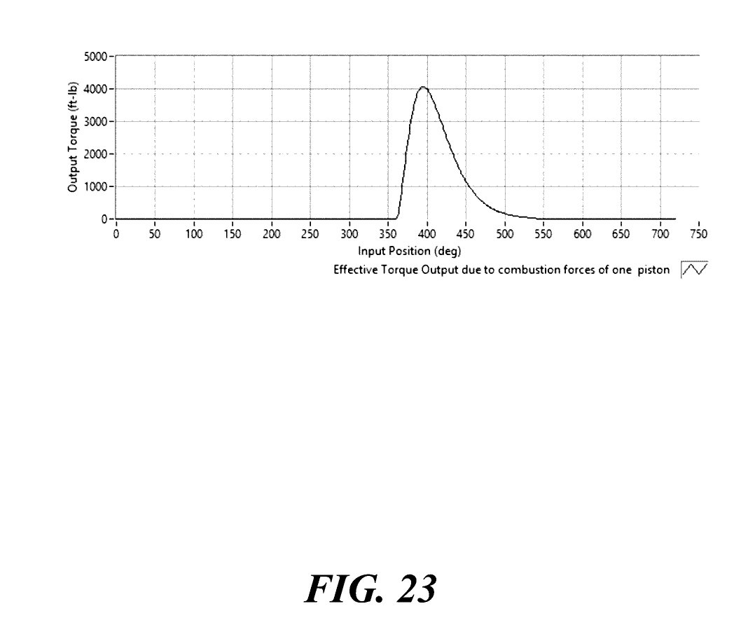

M_{c,hp} is the mean cylinder torque during combustion and is given by:

$${\overline{M}}_{c , hp} = \frac{30 {η}_{vol} {Q}_{HV} {\dot{m}}_{f}}{{ω}_{eng} π} \qquad ( EQUATION 16 )$$

where ηᵥₒₗ is the combustion efficiency, Q_{HV} is the fuel heating value, \dot{m}_{f} is the average mass flow rate, and ω_{eng} is the engine speed. This contribution is shown in FIG. 23.

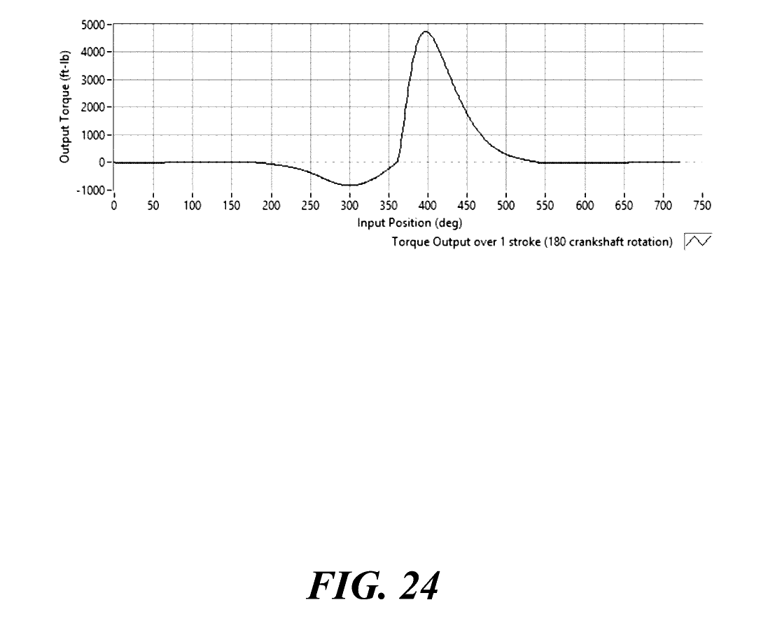

Each piston produces a torque profile such as in FIG. 23. Each pulse is offset by 180° from the last. These torques may then be summed to obtain the torque output characteristics of the four-cylinder diesel engine over all four strokes (720° depicted in FIG. 24.

The envisioned four-bar mechanism will be driven directly from the crankshaft via a one-to-one reduction gear, which means that the input crank will complete a full revolution for every full crankshaft rotation. The optimum output post-mechanism is a perfectly constant torque equal to the average of the torque output in FIG. 7. Consideration of equation 1 leads us to the formulation for the optimum torque output curve for the four-bar which is based on direct computation and modeling. This curve is given by:

T_{4-bar}=T_{Engine}−T_{Out}=T_{Engine}−T̅_{Engine} (EQUATION 17)

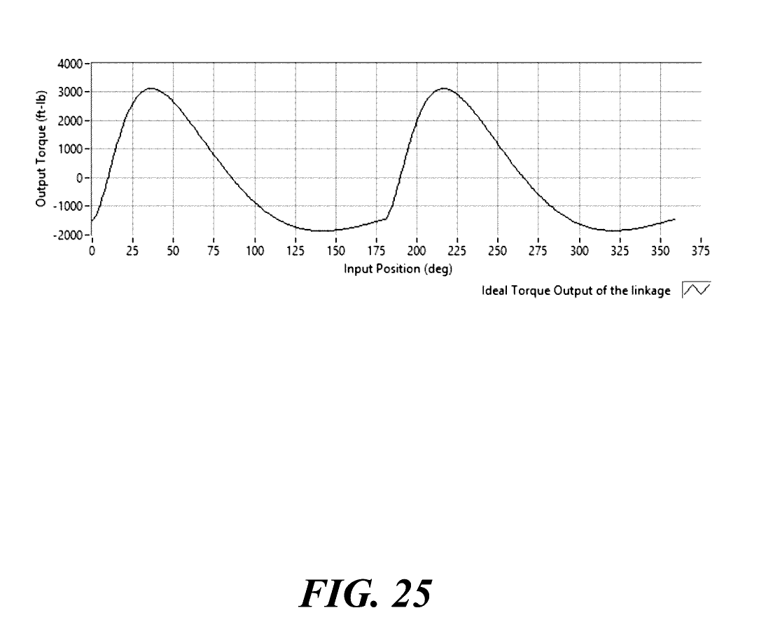

This curve is shown for the engine torque in FIG. 25.

Armed with an understanding of the torque curve to be designed for, the torque pulse compensating mechanism itself may now be better appreciated.

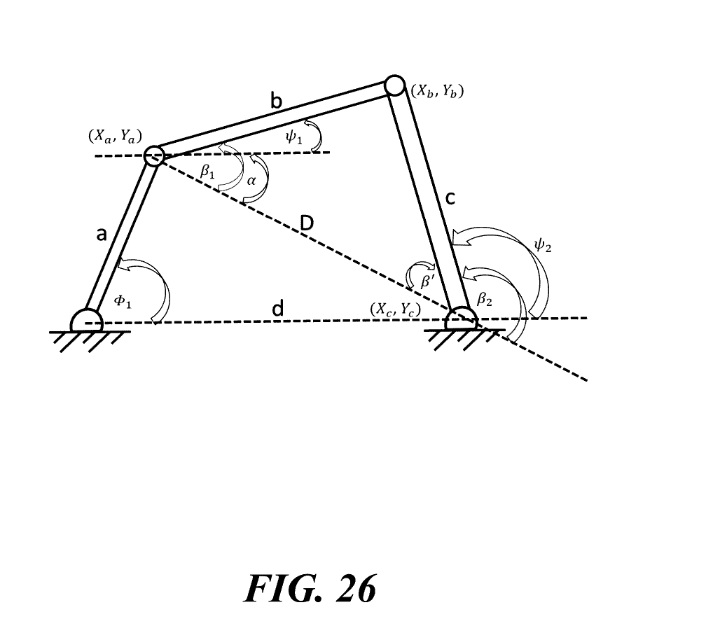

The preferred embodiment of the four-bar mechanism disclosed herein is designed based on the desired dynamic response. It is a goal of this design to provide some desired physical path output. The notation used for the presentation of the kinematic and dynamic state determination is depicted in FIG. 26.

This linkage can only be closed if the vector equation defining its closure is satisfied. A complete derivation of the results of Ferdinand Freudenstein is presented in Tesar, Delbert, “Robotics and Automation” ME 372J Course Material. Spring 2014.

The complex valued vector equation is given by:

a*e^{iΦ}^{₁}+b*e^{iψ}^{₁}c*e^{iψ}^{₂}+d (EQUATION 18)

This is a complex valued vector equation that can be separated into real and complex components and manipulated such that the intermediate angle ψ₁ is eliminated to arrive at a transcendental equation giving ψ₂=f(Φ₁). The transcendental is solved with the application of the half angle trigonometric identities:

$$\begin{matrix}sin ( ψ ) = \frac{2 * tan ( \frac{ψ}{2} )}{1 + {tan}^{2} ( \frac{ψ}{2} )} , \\ and & ( EQUATION 19 ) \\ cos ( ψ ) = \frac{1 - {tan}^{2} ( \frac{ψ}{2} )}{1 + {tan}^{2} ( \frac{ψ}{2} )} , & ( EQUATION 20 )\end{matrix}$$

This yields the analytical result:

$$\begin{matrix}{ψ}_{2} = 2 * {tan}^{- 1} ( \frac{A \pm \sqrt{{A}^{2} + {B}^{2} - {C}^{2}}}{( B + C )} ) & ( EQUATION 21 ) \\ A = sin ( {Φ}_{1} ) & ( EQUATION 22 ) \\ B = - d / a + cos ( {Φ}_{1} ) & ( EQUATION 23 ) \\ C = - d / {c}^{*} cos ( {Φ}_{1} ) + \frac{{a}^{2} + {c}^{2} + {d}^{2} - {b}^{2}}{2 ac} . & ( EQUATION 24 )\end{matrix}$$

in which ψ₁ may be found by returning now to EQUATION 18 and solving to find:

e^{iψ}^{₁}=c/b*e^{iψ}^{₂}+d/b−a/b*e^{iΦ}^{₁} (EQUATION 25)

After separation into real and imaginary components through Euler' s identity, this yields:

$${ψ}_{1} = {tan}^{- 1} ( \frac{Im [ {e}^{{iψ}_{1}} ]}{Re [ {e}^{{iψ}_{1}} ]} ) = {tan}^{- 1} ( \frac{\frac{c}{b} * sin ( {ψ}_{2} ) - \frac{a}{b} * sin ( {Φ}_{1} )}{\frac{c}{b} * cos ( {ψ}_{2} ) - \frac{a}{b} * cos ( {Φ}_{1} ) + \frac{d}{b}} ) \qquad ( EQUATION 26 )$$

The kinematic state of the four-bar linkage is now known for arbitrary geometry as a function of input angle Φ₁. The dynamic analysis that yields the angular velocities and accelerations of links two and three involves taking the derivative of EQUATION 17 which, upon separation, yields two equations in two unknowns for each derivative taken. These may then be solved for the unknowns, resulting in the output dynamic state described by ω₂, ω₃, α₂, α₃, the angular velocities and accelerations of links two and three, respectively.

$$\begin{matrix} {ω}_{2} = \frac{a * sin ( {Φ}_{1} - {ψ}_{2} )}{b * sin ( {ψ}_{2} - {ψ}_{1} )} * {ω}_{1} \\ {ω}_{3} = \frac{a * sin ( {Φ}_{1} - {ψ}_{1} )}{c * sin ( {ψ}_{2} - {ψ}_{1} )} * {ω}_{1} & ( EQUATION 27 ) \\ {α}_{2} = \frac{\begin{matrix}c * {ω}_{3}^{2} - b * {ω}_{2}^{2} * cos ( {ψ}_{1} - {ψ}_{2} ) - \\ a * {ω}_{1}^{2} * cos ( {Φ}_{1} - {ψ}_{2} ) - α * {α}_{1} * sin ( {ψ}_{2} - {Φ}_{1} )\end{matrix}}{b * sin ( {ψ}_{1} - {ψ}_{2} )} & ( EQUATION 28 ) \\ {α}_{3} = \frac{\begin{matrix}b * {ω}_{2}^{2} - a * {ω}_{1}^{2} * cos ( {Φ}_{1} - {ψ}_{1} ) - \\ c * {ω}_{3}^{2} * cos ( {ψ}_{1} - {ψ}_{2} ) - α * {α}_{1} * sin ( {Φ}_{2} - {ψ}_{1} )\end{matrix}}{b * sin ( {ψ}_{1} - {ψ}_{2} )} & ( EQUATION 29 )\end{matrix}$$

The g and h functions that relate the output velocity and acceleration to the input velocity and acceleration may be found by setting ω₁=0 and α₁=1 in the above dynamic equations. This formulation then yields the following completely geometric formulations for these non-linear functions.

$$\begin{matrix} {g}_{mass} = \frac{a * sin ( {Φ}_{1} - {ψ}_{1} )}{c * sin ( {ψ}_{2} - {ψ}_{1} )} \\ and & ( EQUATION 30 ) \\ {h}_{mass} = \frac{\begin{matrix}b * {[ \frac{a * sin ( {Φ}_{1} - {ψ}_{2} )}{b * sin ( {ψ}_{2} - {ψ}_{1} )} ]}^{2} - a * cos ( {Φ}_{1} - {ψ}_{1} ) - \\ c * {[ \frac{a * sin ( {Φ}_{1} - {ψ}_{1} )}{c * sin ( {ψ}_{2} - {ψ}_{1} )} ]}^{2} * cos ( {ψ}_{1} - {ψ}_{2} )\end{matrix}}{b * sin ( {ψ}_{1} - {ψ}_{2} )} & ( EQUATION 31 )\end{matrix}$$

These geometric functions are found to be exactly equal to the coefficients derived in the following manner.

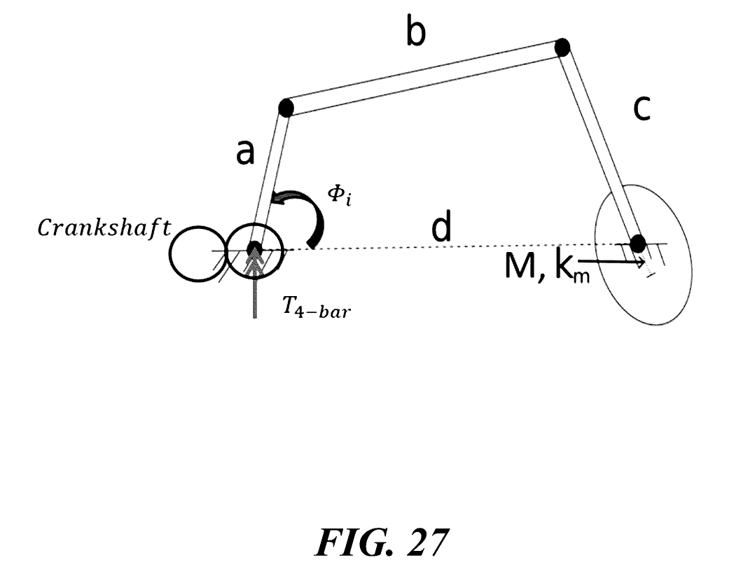

The nonlinear inertia torque T_{d}ⁱ to be developed here is given by EQUATION 32:

$${T}_{d}^{i} = \frac{1}{2} \frac{d {I}^{*}}{d {Φ}_{i}} {ω}_{i}^{2} + {I}^{*} {α}_{i} + {K}^{*} {Φ}_{i} \qquad ( EQUATION 32 )$$

where Φᵢ, ωᵢ, αᵢ are the input angle, angular velocity and acceleration at the input at the ith instant, respectively. The desired configuration consists of a concentrated mass at the output link. Driving this mass with the four-bar may provide the non-linear torque characteristics desired. As the majority of the system mass will be concentrated at this output mass, the kinematic effect of the links themselves on the torque of the system at the input link may be neglected. The configuration under analytical consideration is shown in FIG. 27. It is to be noted that this formulation utilizes the radius of gyration to express the inertia of the balancing mass Ī_{c}, where this radius is interpreted as the distance from the axis one could place a single particle of mass M to have an equivalent mass moment of inertia as the original body.

Returning to EQUATION 32, it may be noted that, that since αᵢ is approximately zero during normal operation, and assuming there are no spring elements in the system, the torque, T_{d}ⁱ, is given by the first term of the right hand side of EQUATION 32. The inertia torque is then given in expanded form as EQUATION 33:

$${T}_{d}^{i} = \frac{1}{2} \frac{d {I}^{*}}{d {Φ}_{i}} = {\sum }_{i = 1}^{L} \{ {I}_{l} {g}_{l} {h}_{l} + {M}_{l} ( {g}_{l}^{x} {h}_{l}^{x} + {g}_{l}^{y} {h}_{l}^{y} ) \} {ω}_{i}^{2} \qquad ( EQUATION 33 )$$

Assuming that the center of gravity of the balancing mass is aligned with the axis of rotation of the rocker link, only the rotational coefficients, gₗ and hₗ survive. These terms may be calculated directly from the kinetic state derived above. The first order coefficient is

gₗ=ωₗ/ωᵢ (EQUATION 34)

while the general formulation for the hⁱₗ functions is given by

$${h}_{l}^{i} = \frac{{ψ}_{1}^{″} - g {Φ}_{i}^{″}}{{( {Φ}_{i}^{′} )}^{2}} \qquad ( EQUATION 35 )$$

Since it has been assumed that the input acceleration is approximately zero for normal operation, hⁱₗ is the ratio of the input velocity to the output acceleration for each link. For the balancing mass under consideration,

gₘₐₛₛ=ωₘₐₛₛ/ωᵢ (EQUATION 36)

and

$${h}_{mass} = \frac{{ψ}_{mass}^{″}}{{( {ω}_{i} )}^{2}} \qquad ( EQUATION 37 )$$

The simplified driving torque is then given by:

T_{d}ⁱ=[I_{massgmass}hₘₐₛₛ]ωᵢ² (EQUATION 38)

where

Iₘₐₛₛ=Mkₘ² (EQUATION 39)

Everything in the expression above is a constant, save the gh products. These terms produce the nonlinearity in the system that may be exploited to achieve a torque curve matching that of FIG. 25.

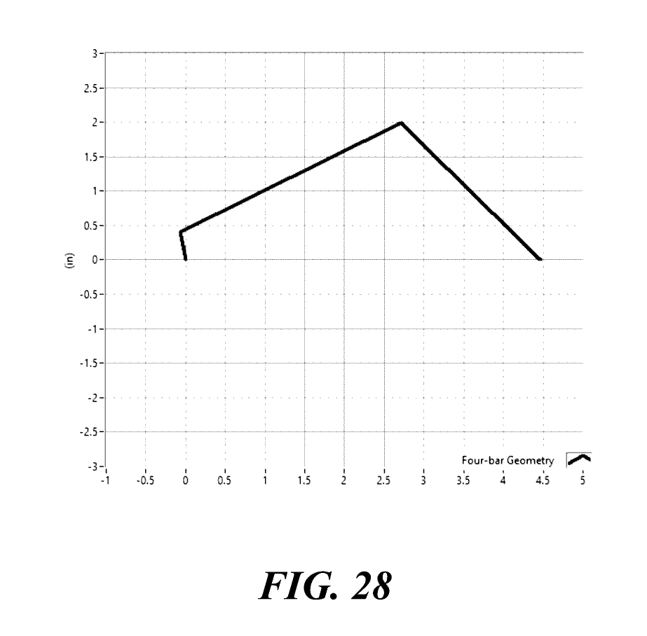

In placing a large balancing mass Ī_{c} at the output crank, the masses of the links in the system may be neglected. Thus, the shape of the resultant torque may be seen directly in the shape of the gh curve for the Ī_{c} mass. The inertia of the mass becomes a scaling constant. Additional design degrees of freedom include the direction of rotation (which may be changed by an intermediate gear of the same reduction), and the input crank initial angle with respect to the engine dynamics output curve. This second degree allows the curve of the dynamics to be shifted left or right. The optimized torque output matching FIG. 25 may be given by the mechanism displayed in FIG. 28. This mechanism is described by the parameters set forth in TABLE 4 below.

TABLE 4
Parameters describing a mechanism with optimized torque output.

| Parameter | Value |
|---|---|
| a (in) | 0.41 |
| b (in) | 3.2 |
| c (in) | 2.65 |
| d (in) | 4.46 |
| Radius of Gyration (in) | 16 |
| Mass (lb) | 12 |
| Initial Crankshaft Angle (deg) | 34 |
| Input Speed (RPM) | 900 |

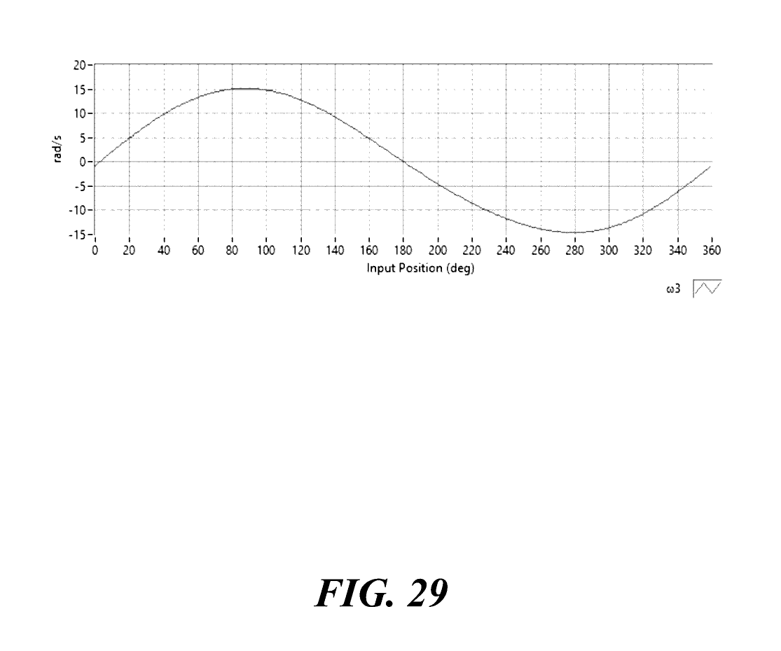

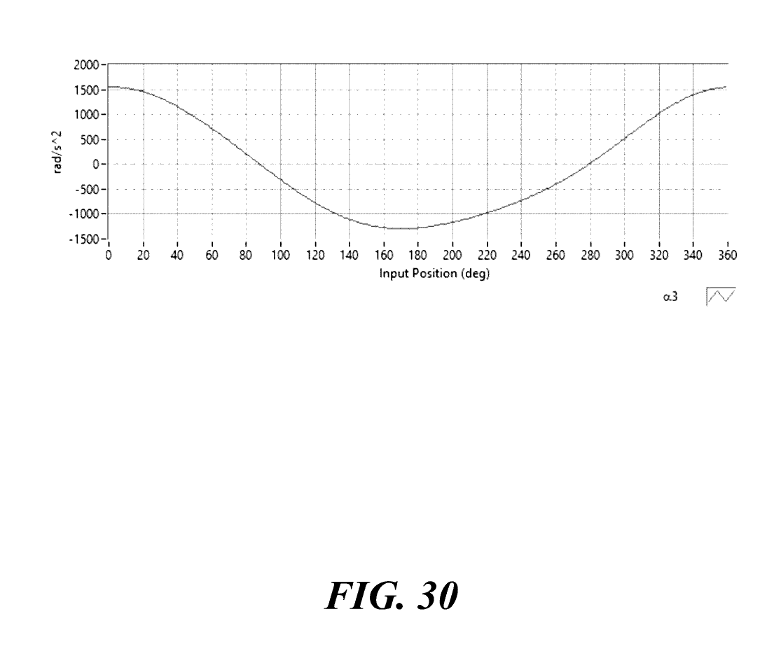

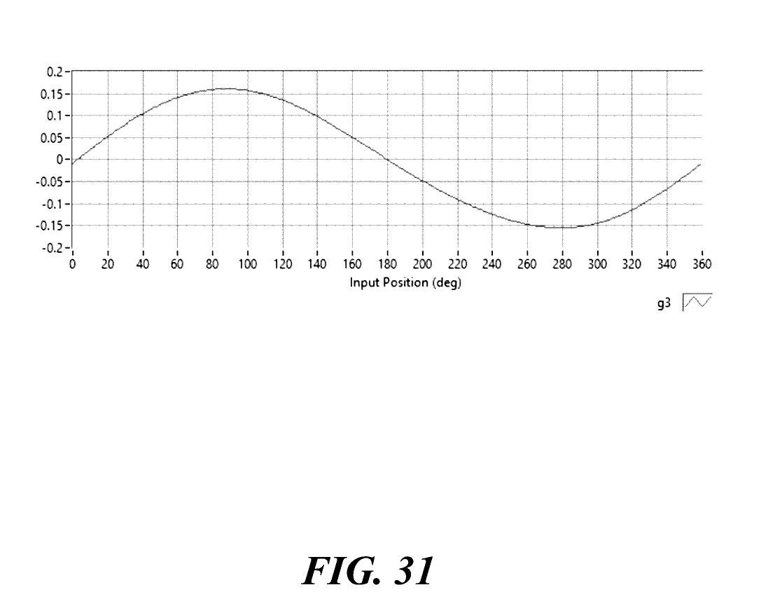

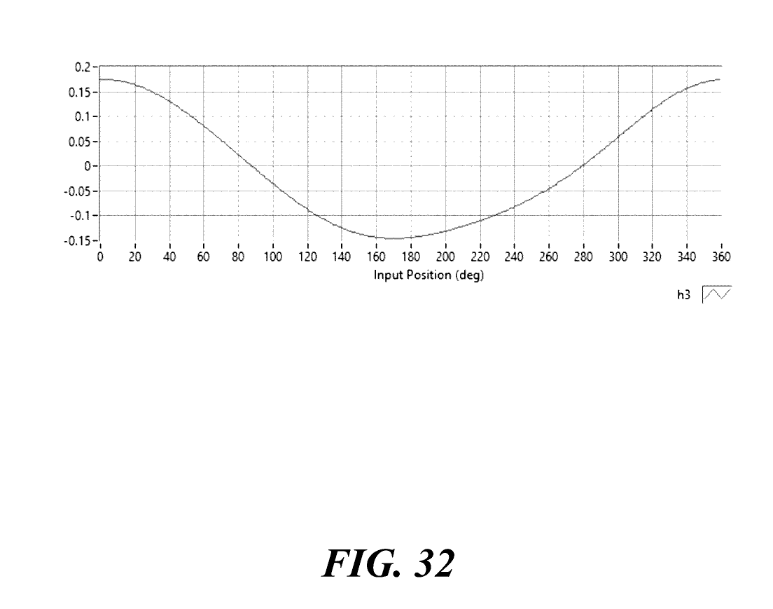

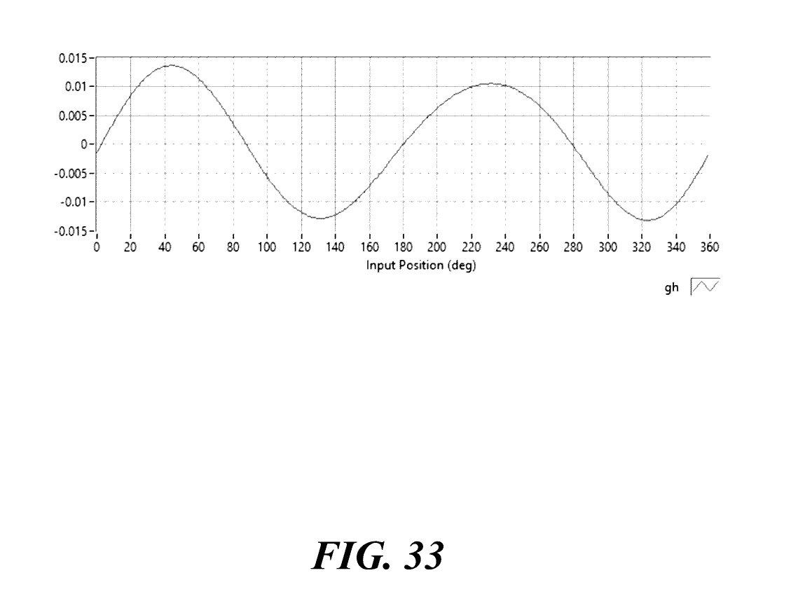

We note that the mechanism is designed for operation at 900 RPM. Off-speed operation will be thoroughly addressed shortly. Furthermore, only the relationship between the lengths of the links matters, the given lengths can be proportionally scaled by any amount without affecting the dynamics of the mechanism. In the case given here, we have chosen a very compact form of the mechanism. The rocker link is shorter than the radius of gyration of the mass that is attached to it. Thus the outer diameter of the balancing mass will lie beyond the edge of the rocker link. The input crank is ¾″ long, and can likely be realized in the form of an eccentric offset gearing mechanism. This recommended design direction will lend durability and ruggedness to the final mechanism. The dynamics of the system lead directly to the g and h curves, as seen in the derivation of these coefficients. These dynamics are depicted in FIGS. 29-33.

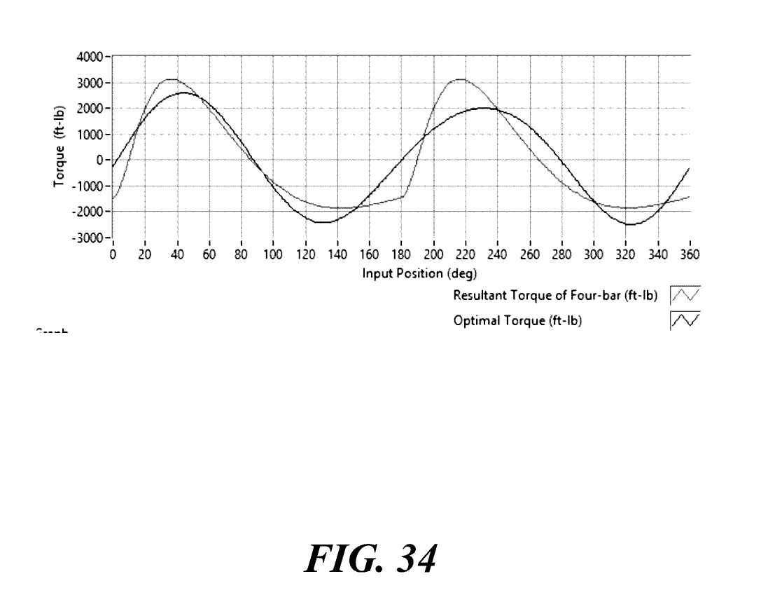

The gh curve resembles the desired output shown in FIG. 25. Overlaying the output torque of the four-bar on the optimal output torque results in FIG. 34.

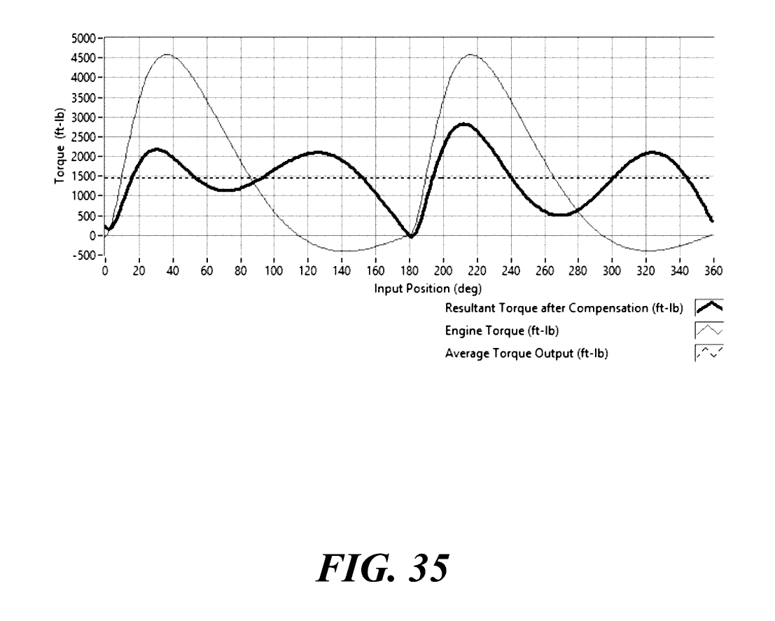

The cancellation properties of this mechanism are highly attractive as seen in FIG. 35. This graph depicts the torque output of the engine, the average of this output, and the resultant torque after cancellation.

The deviation of the engine torque (red), and the four-bar managed torque (white) from the optimum constant average torque (green) is parameterized by the root mean square (RMS) computation. These parameters are given in TABLE 5 for this operating speed.

TABLE 5
Parameters describing a mechanism with optimized torque output.

| Parameter | Value |
|---|---|
| Engine RMS Deviation | 3.198 × 10⁶ |
| Four-bar RMS Deviation | 438930 |
| RMS Deviation Ratio (Design Speed) | 0.137231 |

The quantity RMS torque error ratio is the RMS deviation torque of the four-bar from the average torque divided by the RMS deviation of the torque of the engine from the same. It is therefore a measure of the reduction in torque deviation as a result of the mechanism. For the design speed case, less than 14% of the RMS torque deviation from the average exists after the mechanism applies its optimized non-linear torque. This means that the deviation from average is reduced by more than 7× due to the proposed mechanism. We also find the maximum torque of the engine output, corresponding to the two peaks, and the maximum of the cancelled torque over the entire cycle. The former divided by the latter results in the minimum cancellation factor over the entire cycle which is seen to be an almost 1.6× reduction in peak torque (minimum). This occurs during the second peak of the full cycle, and a greater cancellation factor (better than 2×) occurs for the first peak. The average is also taken, for both the engine and the resultant torque to ensure that the resultant configuration does not reduce the average power delivered by the engine.

TABLE 6
Numerical Torque Cancellation Properties

| Parameter | Value |
|---|---|
| Max Torque of Engine (ft-lb) | 4582.39 |
| Max Torque of Four-bar Managed | 2824 |
| Resultant (ft-lb) | |
| Minimum Cancellation Factor | 1.6 |
| Average Torque of Engine (ft-lb) | 1456.21 |
| Average Torque of Four-bar | 1454.33 |
| Managed Resultant (ft-lb) | |

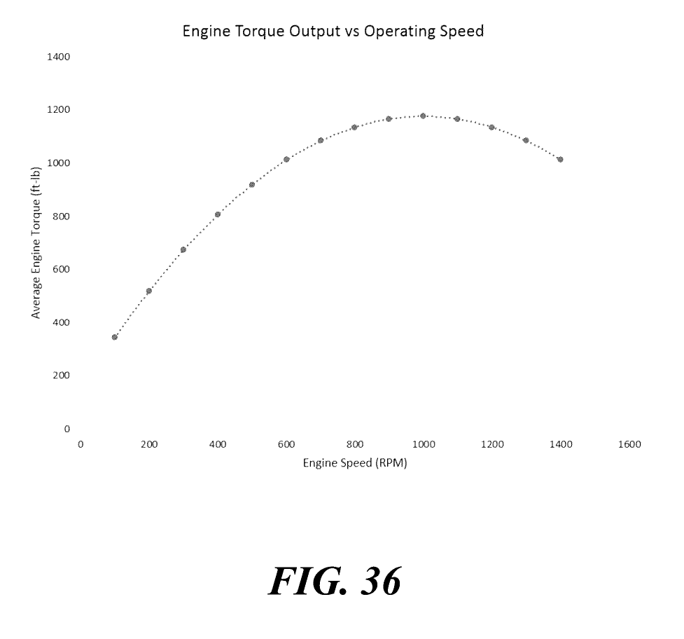

The effect of off-design speed operation is complicated by the fact that both the engine output torque and the inertial torque properties of the four-bar are affected by the angular speed of the crankshaft. In general, as the angular velocity of the four-bar goes down, less inertial torque is transferred to the crankshaft, and less benefit is seen. As the speed increases above the optimal designed speed, the torque pulses provided by the four-bar grow larger than the torque pulses of the engine, again making the system non-beneficial. To simulate the behavior of the average torque of the engine as a function of differing angular velocities, it is first assumed that the engine has been designed such that its peak torque occurs at the design speed (900 RPM), and efforts are taken to ensure that the torque as a function of angular velocity follows the typical nature of the same curve for similarly classed diesel engines. This simulation results in the torque characteristics seen in FIG. 36 which are, again, based on the average torque over the entire cycle.

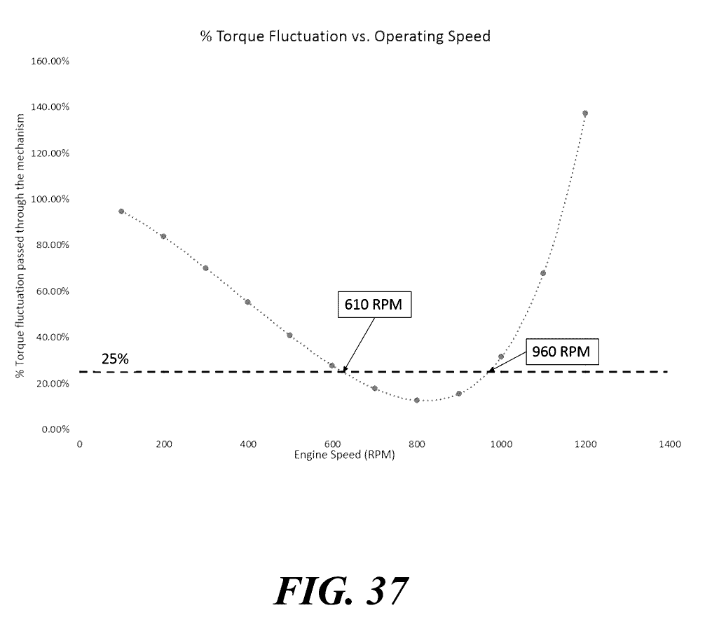

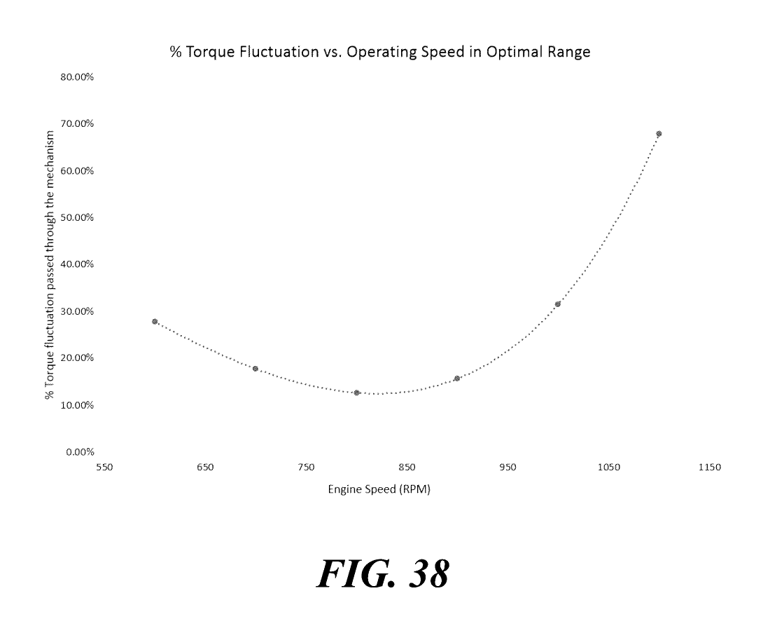

These dependencies are included in the same simulation so that the effect of off-design speed operation may be appreciated. The RMS deviation of the engine torque (from the average torque) at any operational speed is computed in real time by the simulation, as well as the RMS deviation of the four-bar managed resultant. The ratio of the latter to the former provides an indication of the amount of fluctuation from average that is cancelled by the four-bar torque. This ratio is referred to as the percent of torque fluctuation that passes through the damping mechanism. The percent torque fluctuation passed through varies as a function of angular velocity because of the effect on the engine torque curve, as well as the effect on the four-bar torque curve. Data was captured at 100 RPM intervals from 100 RPM to 1400 RPM, resulting in the graph depicted in FIG. 37. These results may be compared to the graph of FIG. 38, which depicts the percent of torque fluctuation that passes through the four-bar mechanism in the optimal range.

The torque fluctuation ratio goes to 1 at 0 RPM, which is to be expected, as the four-bar still requires driving motion to deliver its non-linear torque, despite the fact that this torque is amplified by the nonlinear mechanism. There is an almost linear decrease in the fluctuation passed as the operating speed increases to the design speed, and then a sharp increase above 1100 RPM. This torque fluctuation passed exceeds 100% because the four-bar, driven at these high speeds, generates larger torque pulses than the engine. It is expected that this tuned engine configuration will experience speed variations less than ±20% during steady state operations. This range is in the valley of FIG. 37, indicating maximum mechanism benefit. During the transient stages, as the vehicle is ramping up to steady state speed or idling, the benefit of the mechanism goes down, but so do the size of the torque pulses themselves. The pulses are less damaging to the driveline as the operating speed goes down, so FIGS. 37-38 suggest that these pulses become more abated exactly where they are of a magnitude which would be most damaging to the system.

Flywheel design has been the subject of numerous treatises, of which Norton, Robert, Machine Design, An Integrated Approach (5th ed. Pearson, 2013; Print) is exemplary. The moment of inertia required from a flywheel is typically found as:

$${I}_{fw} = \frac{{E}_{k}}{{C}_{f} {ω}_{avg}^{2}} \qquad ( EQUATION 40 )$$

Here Eₖ is the rotational kinetic energy the flywheel must store, which is given by:

Eₖ=∫_{θ@ω}_{ₘᵢₙ}^{θ@ω}^{ₘₐₓ}(T(θ))dθ (EQUATION 41)

where ω_{avg} is the average angular speed of the driveline (here 900 RPM), and C_{f} is the fluctuation coefficient given by:

$${C}_{f} = \frac{{ω}_{max} - {ω}_{min}}{{ω}_{avg}} \qquad ( EQUATION 42 )$$

It is desirable to find a moment of inertia of the flywheel that would produce system performance similar to the mechanism derived previously. In order to do this, the fluctuation coefficient must be determined that is based on the ωₘₐₓ and ωₘᵢₙ that are allowed with the four-bar torque cancellation curve. These values may be found by starting with EQUATION 41, which is the controlling equation of the system:

\ddot{θ}I=T_{Engine}−T_{load} (EQUATION 43)

Thus, in terms of ω:

$$\dot{ω} = \frac{d ω}{d t} = \frac{( {T}_{Engine} - {T}_{avg} )}{I} \qquad ( EQUATION 44 )$$

where it is assumed that the load torque is equal to the average torque of the engine. This is a separable differential equation, which gives the angular speed variation as an integral over the torque curve as:

∫_{ω}_{^{min}}^{ω}^{ₘₐₓ}dω=∫_{T@ω}_{ₘᵢₙ}^{T@ω}^{ₘₐₓ}(T(t))dt (EQUATION 45)

It is to be noted that the simulation torque data may be integrated with respect to angle or time, since the average speed of rotation is known. These integrations were carried out numerically based on the data generated in simulation. The locations of ωₘₐₓ and ωₘᵢₙ are known from various references, including the Norton treatise referenced above. The speed fluctuation from the four-bar torque curve is

Δω=0.285 rad/s (EQUATION 46)

which, at 900 RPM or 30π rad/s, gives a fluctuation coefficient of C_{f}=0.003. This result is well within the range of “precision machine” as defined by Norton.

The energy absorption was then calculated according to the integral expression for Eₖ, which again was carried out numerically. This yields

Eₖ5,051.81 ft−lb_{f} (EQUATION 47)

The required flywheel inertia may then be found according to EQUATION 39 as

I_{fw}=5.85 lbft−s² (EQUATION 48)

This inertia is quite massive, which is to be expected as it represents the inertia that would be necessary in a traditional flywheel to make the driveline of a highly non-linear diesel engine behave linked a precision machine.

To provide some indication of the required dimensions of the equivalent flywheel, a solid disk configuration is assumed. In this configuration, a 4 ft. diameter flywheel would have to weigh ˜50 lb. in order to compete with the much more compact mechanism disclosed herein which utilizes an inertial content of 0.66 lbft/s². This mechanism will, of course, have additional mass in the form of the material composing the three physical links themselves. Assuming that the weight of the final mechanism is twice the weight of the balancing mass, then from a pure weight content point of view, this mechanism is almost 9 times more efficient at utilizing mass to cancel the torque pulse as a result of the non-linear properties in the four-bar linkage.

The development of a mechanism has been demonstrated herein which has the potential to replace traditional flywheels in large torque fluctuation applications. This mechanism, in its preferred embodiment, consists of a four-bar linkage, which has non-linear properties during its cycle of operation that can act to amplify the torque cancellation effects of a much smaller balancing mass attached to the output rocker than would otherwise be required. This mass has been found to have an inertia content that is nine times less than that of a comparable flywheel. This result correlates directly with an increase in responsiveness, as measured by the dynamic response of the system to a change in operation speed.

At design speed, embodiments of this mechanism have been found to reduce the torque variation from the constant average torque to 14% as compared to the engine torque variation. The effective fluctuation coefficient found, which is normally used to derive required flywheel inertia, was found to be above the level defined in Norton as a precision machine. The surviving torque variations may be expected to cause very low levels of fluctuating stresses on the rest of the driveline of the vehicle, as compared to a normal flywheel. At off-design speed, the performance of this mechanism remains high. At 20% below design speed, the torque fluctuation is reduced by six, at 20% above, this value is 1.6. Since a typical truck may be expected to remain fairly stably centered on its design speed, with the changes in vehicle speed being provided by a wide range of gearing choices, it is expected that this mechanism will remain in a zone of high performance.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims. It will also be appreciated that the various features set forth in the claims may be presented in various combinations and sub-combinations in future claims without departing from the scope of the invention. In particular, the present disclosure expressly contemplates any such combination or sub-combination that is not known to the prior art, as if such combinations or sub-combinations were expressly written out.

What is claimed is:

1. An engine and gear train combination, comprising:
an engine which drives a first crankshaft having a first gear disposed thereon;
a second crankshaft having a second gear and a flywheel disposed thereon, wherein said second gear meshes with said first gear; and
a torque ripple compensator having a central element which is pivotally connected on a first end thereof to a first set of lateral members, and which is pivotally connected on a second end thereof to a second set of lateral elements;
wherein each element of the first set of lateral elements is also pivotally connected to the second crankshaft.

2. The engine and gear train combination of claim 1, wherein the first set of lateral elements is pivotally connected to a first mount.

3. The engine and gear train combination of claim 1, wherein the second set of lateral elements is pivotally connected to a second mount.

4. The engine and gear train combination of claim 2, wherein the second set of lateral elements is pivotally connected to a second mount, and wherein said first and second mounts are disposed on a common substrate.

5. The engine and gear train combination of claim 2, wherein said first mount comprises first and second mounting elements having opposing planar surfaces, and wherein said first set of lateral elements is disposed between said opposing planar surfaces.

6. The engine and gear train combination of claim 4, wherein said second mount comprises first and second mounting elements having opposing planar surfaces, and wherein said second set of lateral elements is disposed between said opposing planar surfaces.

7. The engine and gear train combination of claim 1, wherein said first set of lateral members includes a first member disposed on a first side of said central element, and a second member disposed on a second side of said central element.

8. The engine and gear train combination of claim 1, wherein said second set of lateral members includes a first member disposed on a first side of said central element, and a second member disposed on a second side of said central element.

9. The engine and gear train combination of claim 1, wherein said first and second gears provide a 2-to-1 gear amplifier.

10. The engine and gear train combination of claim 1, wherein said first set of lateral members includes a first member disposed on a first side of said central element, and a second member disposed on a second side of said central element.

11. The engine and gear train combination of claim 1, wherein said torque ripple compensator includes a plurality of torque ripple compensators, wherein said engine and gear train are disposed in a vehicle having a plurality of wheel hubs, and wherein each of said plurality of torque ripple compensators is disposed in one of said wheel hubs.

12. A driveline, comprising:
an engine;
a first rotary mass; and
a non-linear inertia torque generator disposed between said engine and said rotary mass, wherein said torque generator is equipped with a second mass which is movably disposed on a radius, and an actuator which adjusts the inertia of the torque generator by moving said second mass along said radius.

13. The driveline of claim 12, wherein said rotary mass is a flywheel.

14. The driveline of claim 12, wherein the inertia of the torque generator is adjustable over engine speeds within the range of 500 rpm to 1500 rpm.

15. A method for varying the compensation for torque ripple with speed in a driveline, comprising:
providing a driveline which includes (a) an engine, (b) a first rotary mass, (c) a non-linear inertia torque generator disposed between the engine and the rotary mass, and (d) a second mass which is repositionable on a radius, wherein the inertia of the torque generator varies with the position of the second mass on the radius;
determining the speed at which the engine is operating;
determining a desired inertia for the torque generator at the determined speed; and
adjusting the position of the second mass on the radius to achieve the desired inertia.

16. The method of claim 15, wherein the position of the second mass on the radius is adjusted with an actuator.

17. The method of claim 15, wherein the inertia of the torque generator is adjustable over engine speeds within the range of 500 rpm to 1500 rpm.
